(19) United States
(12) Patent Application Publication
(10) Pub. No.: US 2020/0357087 A1
(43) Pub. Date: Nov. 12, 2020

(54) SYSTEMS AND METHODS FOR PROVIDING VENDOR AND SERVICE LEVEL AGREEMENT MANAGEMENT

(71) Applicant: Venminder, Inc., Elizabethtown, KY (US)

(72) Inventor: Dana A. Bowers, Elizabethtown, KY (US)

(21) Appl. No.: 16/858,107

(22) Filed: Apr. 24, 2020

Related U.S. Application Data
(60) Provisional application No. 62/839,222, filed on Apr. 26, 2019.

(51) Int. Cl. G06Q 50/18; G06Q 30/00; G06Q 10/10; G06F 16/23; G06F 16/2458; G06F 3/0482

(52) U.S. Cl. CPC G06Q 50/182; G06Q 30/01; G06Q 10/109; G06Q 40/02; G06F 16/2477; G06F 3/0482; G06F 16/2379

(57) ABSTRACT

Methods and systems are presented herein for setting up, recording, remediating, and managing Service Level Agreements (SLA) between a financial institution, and one or more vendors providing services and/or other products to the financial institution.

### FIELD OF THE INVENTION

This invention relates generally to systems and methods for managing client/vendor relationships. More particularly, in certain embodiments, the invention relates to systems and methods for providing vendor and agreement management.

### BACKGROUND

Financial institutions such as banks and credit unions are increasingly relying on third-party vendors to perform various important functions. While this improves efficiency and reduces cost for the financial institution, there are various risks posed by such outsourcing. A financial institution (“FI”) must establish a vendor oversight program to mitigate such risks, comply with various regulations, and pass examination by auditors. Generally, maintaining oversight of different vendors and vendor products requires a coordination of large amounts of oversight requirements, tasks, documents, results, due dates, and individuals.

The vendor management process has historically been disjointed, messy, and time-consuming. A single financial institution may have numerous vendors to manage, and there may be many individuals within a given financial institution who deal with a given vendor and must coordinate collection of documents and data regarding the corresponding vendor products. Furthermore, the terms of various contracts between a financial institution and its vendors must be carefully monitored.

Moreover, financial institutions may wish to maintain different types of information about the vendors and vendor products with which they are associated. Traditional vendor management systems allow financial institutions to maintain information according to a predetermined set of fields.

There is a need for a consolidated, efficient system for managing contracts between a financial institution and its vendors.

### SUMMARY

Methods and systems are presented herein for setting up, recording, remediating, and managing Service Level Agreements (SLA) between a financial institution and one or more vendors providing services and/or other products to the financial institution.

In one aspect, the invention is directed to a method for managing service level agreements associated with one or more vendors and/or products. In some embodiments, the method includes a step of causing to display, by a processor of an enterprise system, one or more graphical user interfaces (GUIs) associated with one or more service level agreement modules, the service level agreement modules. In some embodiments, the service level agreement modules include a set up module to set up and/or establish a new service level agreement (e.g., a service level agreement entry in a database of the enterprise system); a record module to record (e.g., in a database of the enterprise system) performance of one or more service level agreements; a remediate module to manage remediation of one or more service level agreements; and/or a manage module to display information (e.g., statistical information) relating to one or more service level agreements.

In some embodiments, the method includes a step of receiving, by a processor of an enterprise system, a first input from a first client user (e.g., said first client user having been authorized to access the enterprise system, e.g., said first client user being one member of a network of subscribed clients). In some embodiments, the first input includes instructions to access a selected module of the one or more service level agreement modules.

In some embodiments, the method includes a step receiving, by the processor of the enterprise system, subsequent input from the first client user specific to the selected service level agreement module.

In some embodiments, the method includes a step updating, in a memory of the enterprise system, service level agreement information stored in association with the first client, based on the subsequent input. In some embodiments, the service level agreement module is configured to define and track performance metrics associated with one or more service level agreements.

In some embodiments, the one or more graphical user interfaces (GUIs) associated with one or more service level agreement modules comprises a service level agreement home GUI, the service level agreement home GUI. In some embodiments, the service level agreement GUI includes a selectable (e.g., clickable) set up tile associated with the set up module; a selectable (e.g., clickable) record tile associated with the record module; a selectable (e.g., clickable) remediate tile associated with the a remediate module; and/or a selectable (e.g., clickable) manage tile associated with a manage module.

In some embodiments, the first input comprises instructions to access the set up module (e.g., by clicking the set up tile on the a service level agreement home GUI). In some embodiments, a subsequent input comprises custom data field information relating to a service level agreement (e.g., received via a graphical user interface widget), the custom data field information including one or more identifiers and/or one or more monitoring parameters associated with the service level agreement.

In some embodiments, the method includes interrogating, by the processor, a database of the enterprise system to determine whether at least one service level agreement entry have been set up in the database of the enterprise system. In some embodiments, the method includes, if no service level agreement entry is found, blocking (e.g., rendering non-clickable) one or more of the record tile, the remediate tile, and/or the manage tile. In some embodiments, the method includes, if at least one service level agreement entry is found, activating (e.g., rendering clickable) one or more of the record tile, the remediate tile, and/or the manage tile.

In some embodiments, a first input comprises instructions to access the record module, and wherein a subsequent input comprises custom data field information including one or more filter parameters.

In some embodiments, the method includes interrogating, by the processor, an electronic calendar to determine a current date. In some embodiments, the method includes interrogating, by the processor, a database of the enterprise system, to retrieve, for one or more service level agreement entries, one or more review windows comprising a start date and an end date, and one or more as-of dates associated with one or more reviews. In some embodiments, the method includes. if, for a first service level agreement, the current date is one day greater than the start date of a first review windows and if none of the one or more as-of dates that falls within the first review window, assigning to the first service level agreement a past due value; In some embodiments, the method includes displaying, on a monitoring GUI, a past due reminder date (e.g., in a font color different from a default font color for display of reminder dates that are not past due).

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of an example system for managing contracts between a financial institution and its vendors.

FIG. 2 is a block diagram of the example system for managing contracts between the financial institution and its vendors in accordance with an embodiment of the invention.

FIG. 3 is an example main dashboard in accordance with an embodiment of the invention.

FIG. 4 is an example vendor dashboard in accordance with an embodiment of the invention.

FIG. 5 is an example document storage page in accordance with an embodiment of the invention.

FIG. 6 is an example workflow of the system in guiding an end-user in preparing a vendor oversight report associated with one or more selected vendor products in accordance with an embodiment of the invention.

FIG. 7 is an example vendor exam preparation workspace in accordance with an embodiment of the invention.

FIG. 8 is an example workspace for collecting documents by matching collected end-user's document to a list of suggested documents in accordance with an embodiment of the invention.

FIG. 9 is an example workspace for collecting documents by prompting the end user for selection of actions for unassigned documents that have been provided by the end user in accordance with an embodiment of the invention.

FIG. 10 is an example workspace for collecting documents by prompting the end user for selection of actions for unassigned suggested documents in accordance with an embodiment of the invention.

FIG. 11 is an example workspace for preparing a collected document for the examination report in accordance with an embodiment of the invention.

FIG. 12 is an example workspace for uploading document to be attached and included in the examination in accordance with an embodiment of the invention.

FIG. 13 is an example workspace to previewing contents to be included in the examination report.

FIG. 14 is an example workspace to review vendor products in accordance with an embodiment of the invention.

FIG. 15 is an example display for viewing product review in accordance with an embodiment of the invention.

FIG. 16 is an example alert and information display in accordance with an embodiment of the invention.

FIG. 17 is an example diagram illustrating connections between contracts, products, and Service Level Agreements, in accordance with an embodiment of the invention.

FIG. 18 is an example workflow diagram of the system to guide a user through an example process for setting up, recording, remediating and managing Service Level Agreements in accordance with an embodiment of the invention.

FIG. 19 is an example workflow diagram of the system to guide a user through an example process for setting up, recording, remediating, and managing Service Level Agreements in accordance with an embodiment of the invention.

FIG. 20 is an example workflow diagram of the system to guide a user through an example process for setting up, recording, remediating and managing Service Level Agreements in accordance with an embodiment of the invention.

FIG. 21 is an example workflow diagram of the system to guide a user through an example process for setting up, recording, remediating and managing Service Level Agreements in accordance with an embodiment of the invention.

FIG. 22 is an example software setting workspace, in accordance with an embodiment of the invention.

FIG. 23 is an example SLA indicator workspace displaying contract details view, in accordance with an embodiment of the invention.

FIG. 24 is an example SLA modal window in a contract details entry workspace, including a view all SLAs for this vendor button, in accordance with an embodiment of the invention.

FIG. 25 is an example SLA management selection button, e.g., as displayed on an example main dashboard 202, in accordance with an embodiment of the invention.

FIG. 26 is an example main dashboard—SLA at a glance—status view window, in accordance with an embodiment of the invention.

FIG. 27 is an example main dashboard—SLA at a glance—remediation view window, in accordance with an embodiment of the invention.

FIG. 28 is an example main dashboard—SLA at a glance—category view window, in accordance with an embodiment of the invention.

FIG. 29 is an example main dashboard—quick stats window, in accordance with an embodiment of the invention.

FIG. 30 is an example SLA landing page (No SLAs) workspace, in accordance with an embodiment of the invention.

FIG. 31 is an example SLA landing page (SLAs entered) workspace, in accordance with an embodiment of the invention.

FIG. 32 is an example vendor and product selection workspace, in accordance with an embodiment of the invention.

FIG. 33 is an example additional SLA information input workspace, in accordance with an embodiment of the invention.

FIG. 34 is an example SLA details workspace, in accordance with an embodiment of the invention.

FIG. 35 is an example SLA monitoring setup workspace, in accordance with an embodiment of the invention.

FIG. 36 is an example SLA submitted modal workspace, in accordance with an embodiment of the invention.

FIG. 37 is an example SLA monitoring landing page workspace, in accordance with an embodiment of the invention.

FIG. 38 is an example record SLA information well workspace, in accordance with an embodiment of the invention.

FIG. 39 is an example record vendor SLA performance workspace, in accordance with an embodiment of the invention.

FIG. 40 is an example SLA performance review verification confirmation modal window, in accordance with an embodiment of the invention.

FIG. 41 is an example SLA performance review confirmation modal workspace, in accordance with an embodiment of the invention.

FIG. 42 is an example SLA remediation landing page workspace, in accordance with an embodiment of the invention.

FIG. 43 is an example SLA update remediation page workspace, in accordance with an embodiment of the invention.

FIG. 44 is an example update remediation information well workspace, in accordance with an embodiment of the invention.

FIG. 45 is an example SLA remediation journal entry workspace, in accordance with an embodiment of the invention.

FIG. 46 is an example confirm remediation resolution modal workspace, in accordance with an embodiment of the invention.

FIG. 47 is an example manage SLA's landing page, in accordance with an embodiment of the invention.

FIG. 48 is an example SLA quick stats workspace, in accordance with an embodiment of the invention.

FIG. 49 is an example SLA at a glance workspace, in accordance with an embodiment of the invention.

FIG. 50 is an example SLA details list workspace, in accordance with an embodiment of the invention.

FIG. 51 is an example view SLA details workspace, in accordance with an embodiment of the invention.

FIG. 52 is an example view SLA history workspace, in accordance with an embodiment of the invention.

FIG. 53 is an example SLA performance review detail workspace, in accordance with an embodiment of the invention.

FIG. 54 is an example SLA remediation event detail workspace, in accordance with an embodiment of the invention.

FIG. 55 is an example edit SLA details workspace, in accordance with an embodiment of the invention.

FIG. 56 is an example edit SLA details workspace, in accordance with an embodiment of the invention.

FIG. 57 is an example view vendor SLAs—active workspace, in accordance with an embodiment of the invention.

FIG. 58 is an example view vendor SLA active tab actions workspace in accordance with an embodiment of the invention.

FIG. 59 is an example archive confirmation modal workspace, in accordance with an embodiment of the invention.

FIG. 60 is an example view vendor SLAs—archived workspace, in accordance with an embodiment of the invention.

FIG. 61 is an example view vendor SLA archived tab actions workspace, in accordance with an embodiment of the invention.

FIG. 62 is an example delete confirmation modal workspace, in accordance with an embodiment of the invention.

FIG. 63 is an example restore SLA modal workspace, in accordance with an embodiment of the invention.

FIG. 64 is an example reporting—SLA inventory landing page workspace, in accordance with an embodiment of the invention.

FIG. 65 is an example reporting—SLA performance landing page workspace, in accordance with an embodiment of the invention.

FIG. 66 is an example reporting—SLA remediation landing page workspace, in accordance with an embodiment of the invention.

FIG. 67 is an example reporting—SLA performance trends landing page workspace, in accordance with an embodiment of the invention.

FIG. 68 is an example SLA performance trends graphical report workspace, in accordance with an embodiment of the invention.

FIG. 69 is a block diagram of an example network environment for use in the methods and systems for analysis of spectrometry data, according to an illustrative embodiment.

FIG. 70 is a block diagram of an example computing device and an example mobile computing device, for use in illustrative embodiments of the invention.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### Definitions

Cure Period: As used herein, the term “cure period” refers to a time period specified for the performance metric the SLA is measuring to be improved.

Escalation Contact: As used herein, the term “escalation contact” refers to a person(s) on the SLA Team that will receive email notifications when an SLA reaches a boundary that requires escalation

Penalty: As used herein, the term “penalty” refers to either a financial or contractual penalty associated with an SLA that reaches a boundary that requires a penalty.

Range: As used herein, the term “range” refers to the specified range that a performance metric is expected to fall within.

Remediation: As used herein, the term “remediation” refers to the prescribed steps or plan that is taken to return the SLA to a successful performance boundary SLA Manager: As used herein, the term “SLA manager” refers to the person/user with the overall responsibility for the SLA

SLA Monitor: As used herein, the term “SLA monitor” refers to the person/user with day to day responsibilities for the SLA.

### DETAILED DESCRIPTION

Methods and systems are presented herein for assessing risk associated with a vendor providing services and/or other products to a financial institution, for preparation of associated risk assessment reports or vendor oversight reports, and for maintenance of a plurality of risk assessment reports associated with a plurality of vendors.

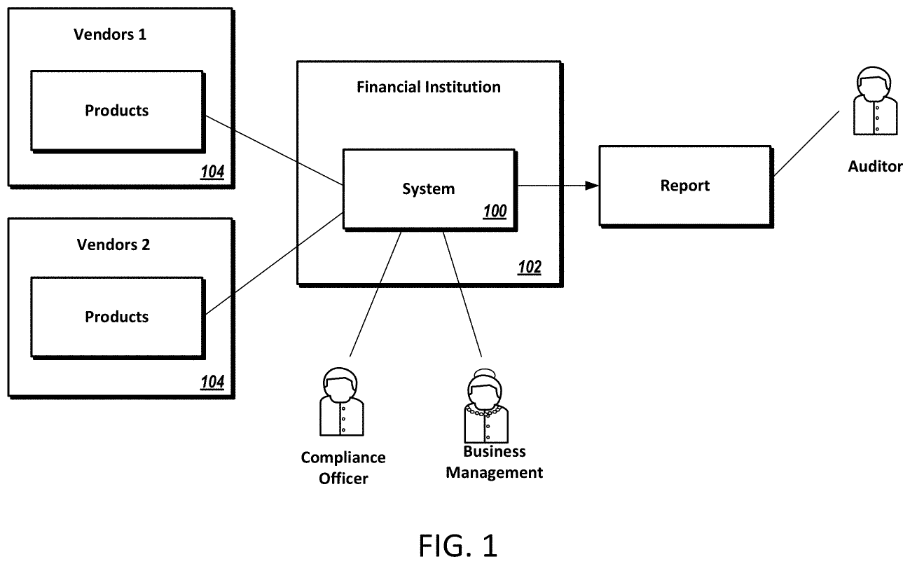

FIG. 1 is a block diagram of an example system 100 to assist financial institutions 102 to manage vendors 104 in accordance with an embodiment of the invention. In some implementations, the system 100 provides guided workflow to i) manage contracts with a given vendor 104, to provide a guided workflow to assist the financial institution 102 to prepare for an compliance or contract audit examination, ii) provide a rating system of the vendors 104 and their products and services, iii) provide a risk-assessment rating-system for the vendors 104, and iv) provide mechanisms for collaboration, the tracking of communication, and document storage.

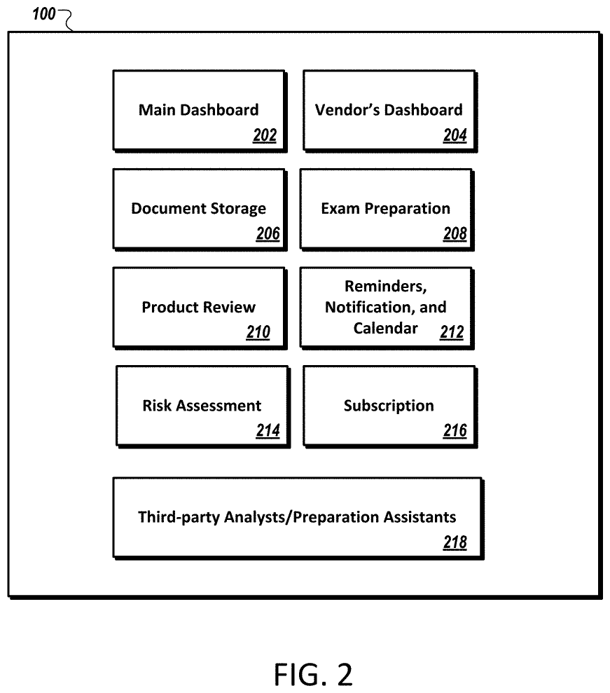

FIG. 2 is a block diagram of the example system 100 for managing contracts between the financial institution and its vendors in accordance with an embodiment of the invention. The system 100 may include a main dashboard 202 for managing actions associated with a given vendor 104 and to track such actions. The system 100 may include a vendor dashboard 204 to view and manage products and vendors associated with a given financial institution. The system 100 may include a document storage page 206 to view and manage documents associated with the vendors and their products. In some implementations, the document storage page 206 may be accessible via the main dashboard 202 and the vendor dashboard 204.

The system 100 may include a reminder, notification, and/or calendar function 212. The function 212 may manage and store a list of dates associated with expiration of a given document or contract as well as a list of personal reminders provided by the end-users. The function 212 may display such reminders in a calendar display. The function 212 may send notifications to the end-user based on pre-defined rules associated with an examination. The rules may be related to the expiration date of a given product or agreement, a scheduled examination, a risk-assessment evaluation, and etc.

The function 212 may include an alert and/or information feed (e.g., new documents uploaded, new reviews added, status update on a given examination or preparation process, etc.). The alert may include a progress bar to indicate a given end-user progress with a given task.

The alert may include an experience bar to indicate a given end-user usage level associated with the various functions of the system 100.

The system 100 may include a risk-assessment module 214 to guide an end-user in assigning a risk rating for a given vendor and/or product. The risk-rating may be utilized as part of the reporting of the compliance and/or contract audit examination. In some implementations, the risk rating may be used to determine the types of information and the types of documents to include in the examination report.

The system 100 may include a subscription module 216. The subscription module 216 may manage and maintain usage by the end-user of the various system components (e.g., 202, 204, 206, 208, 210, 212, and 214) for a given financial institution. The system 100 may monitor the end-user's action, such as the usage of complimentary tools and document storage, purchases of additional tools and document storage, purchases of enterprise features, among others.

In some example embodiments, the system may include one or more modules for executing, providing and/or causing to display one or more graphical user interfaces (GUIs) and/or widgets. The GUIs and/or widgets may include a vendor profile widgets for, among other things, managing vendor profiles; oversight grid widgets for, among other things, providing grid-based oversight of oversight requirements; task widgets for, among other things, managing tasks associated with oversight requirements; oversight management widgets for, among other things, managing tasks and oversight requirements associated with vendors and/or vendor products; document widgets for, among other things, managing documents associated with tasks; administrator widgets for, among other things, managing users; dashboard widgets for, among other things, managing outstanding tasks and vendor products associated with users; and reports widgets for, among other things, generating status, task and/or vendor reports.

In some example embodiments, data associated with vendors (e.g., vendor management information), which is used by the GUIs and/or widgets, may be stored in a memory of the system 100 or of a client computing device associated with the system 100. In some example embodiments, the system 100 is an enterprise system with which one or more enterprise client computing devices are connected. The GUIs and/or widgets are described in further detail below.

Main Dashboard

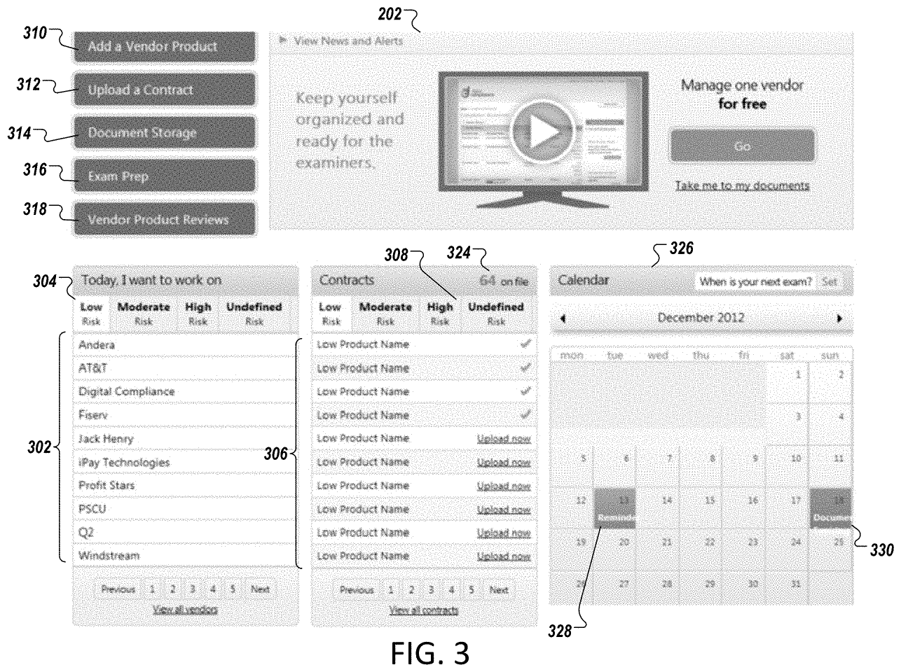

FIG. 3 is an example main dashboard 202 in accordance with an embodiment of the invention. The main dashboard 202 may be used to initiate the various functions, as described in relation to FIG. 2. The main dashboard 202 may display a vendor list 302, which may be organized and filtered by a vendor's risk level 304 (e.g., low, medium, high, or undefined/unknown). The main dashboard 202 may display a contract list 306, which may also be organized and filtered by risk levels 308. The main dashboard 202 may display a number of contracts on file (324), such as those stored in the document storage 206.

The main dashboard 202 may include a calendar 326 that displays reminder dates 328 and expiration dates 330 of contracts, of risk assessment of vendors and/or products, as well as of upcoming examinations. In some implementations, the calendar 326 may include dates in which notifications will be sent by the system. In some implementations, the calendar 326 may only display the expiration dates for documents that are uploaded by the end-user.

In some implementations, upon selecting a date in the calendar 326, the system 100 may prompt the end-user to create a reminder (e.g., for email communication, SMS-message, and other methods of notification accessible to and specified by the end-user). The system 100 may display a content of a reminder when the end-user hovers the cursor thereover. The calendar may be a part of the reminders, notification, and calendar function 212. The alerts and reminders of the calendar 326 may be employed to notify the end-user of upcoming critical dates (e.g., renewal date). The notification may be generated based on the date of the given activity having met an alert condition (e.g., exceeding a date threshold in relation to the critical date).

The main dashboard 202 may include a function to add a vendor product (310), a function to upload a contract associated with a given product (312), a function to manage stored documents (314), a function to prepare for an examination (316), and a function to review and manage reviews for a given vendor products (318).

The main dashboard 202 may be displayed to the users upon login to the system 100.

In some implementations, when adding a new vendor product (310), the system 100 may present the end user with a list of products. The list may include all products associated to the financial institution, including those that are not currently being managed by any of the end-user of that institution as well as those that do not have a contract loaded. The list of products may be maintained within a database that is managed by the system 100.

When adding a new vendor product, the system 100 may present the end-user with a list of questions associated with the product. The questions may include a request for the vendor name, the product name, the product type, and a risk level. The risk level may be defined as low, medium, high, and undefined (as corresponding to the risk level 304). Alternatively, the risk level may be an input from the risk-assessment module 214.

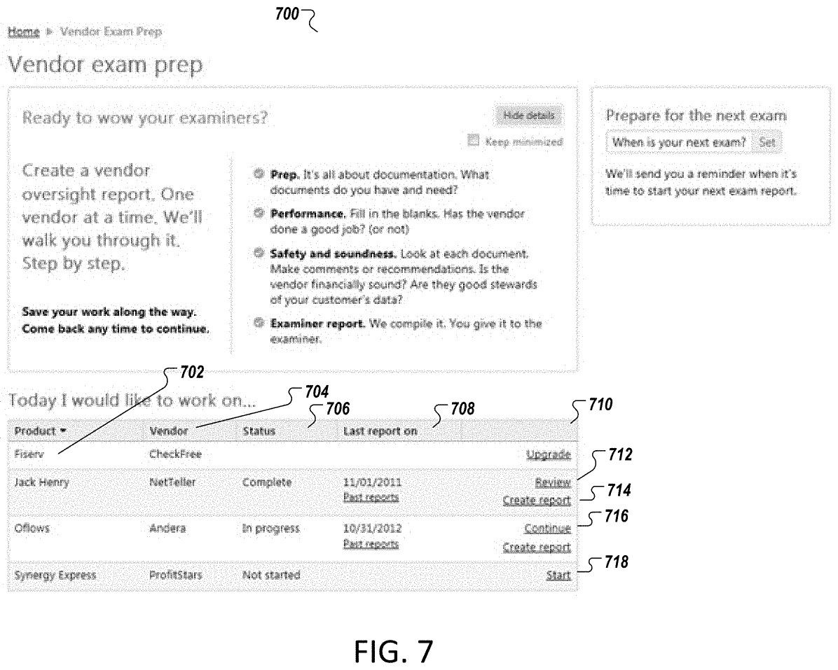

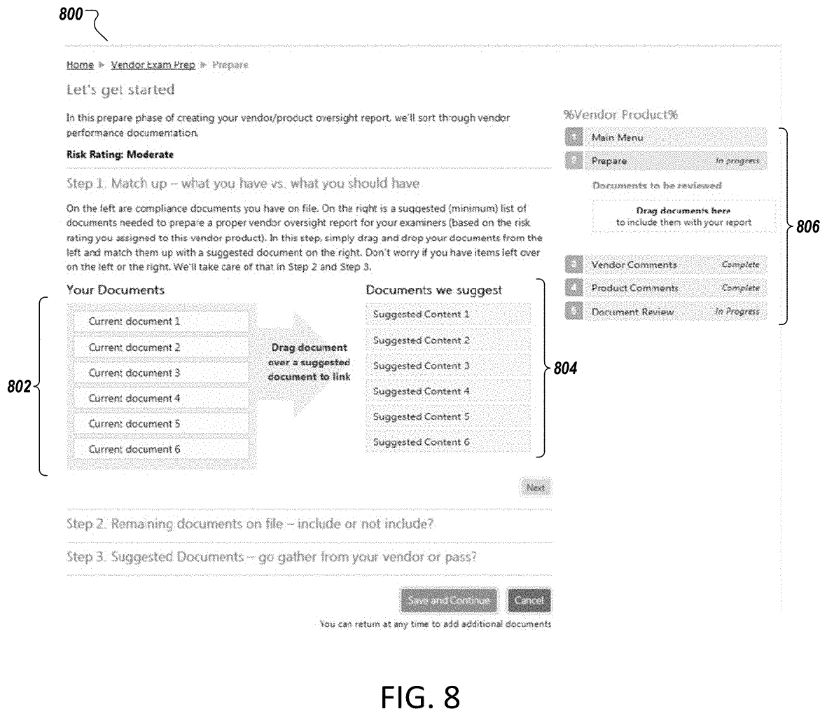

In some implementations, the risk-levels 304, 308 may be used to determine a suggested document 320 (see—see FIG. 8) in the examination-preparation area 322 (not shown—see FIGS. 7-13). Once the vendor product is added, the system 100 may present the end-user with a notification that the product has been added. In the notification, the system 100 may include a link or a selection that allows the end-user to upload a contract associated with the added vendor product. The system may also provide a link or selection to add a collaborator or to add contact information of the vendor.

In some implementations, the system 100 allows more than one person to interact with a vendor. The collaboration function allows the system 100 to receive information from the end-user about co-workers or other people in the end-user's organization that may perform actions or provide reviews for a given vendor and/or vendor product. In some implementations, the collaborator may perform any of the end-user's function (e.g., upload contract, add notes and reminders, save email conversation, and document events), though may not change or undo any of the actions performed by the end-users. Each of the vendor products may be assigned a different point of contact (i.e., a product manager). The system 100 may provide a search function for the end-user to determine if an added collaborator is already registered with the system 100.

In some implementations, when uploading a contract associated with a given product (312), the system 100 may prompt the end-user for a file. Multiple files may be selected and uploaded in a given instance. The system 100 may send a notification to the end-user that the contract has been uploaded and that a notification will be sent when it is ready for review. In some implementations, the contract may be transmitted to a third-party that analyzes and/or prepare the contract for review by the end-user. The system 100 may use aliases table. Examples of tools utilized by the third-party to analyze and prepare the contract are described in Appendices E and F of the U.S. Provisional Patent Application No. 61/805,066, which is incorporated by reference herein in its entirety.

Vendor Dashboard

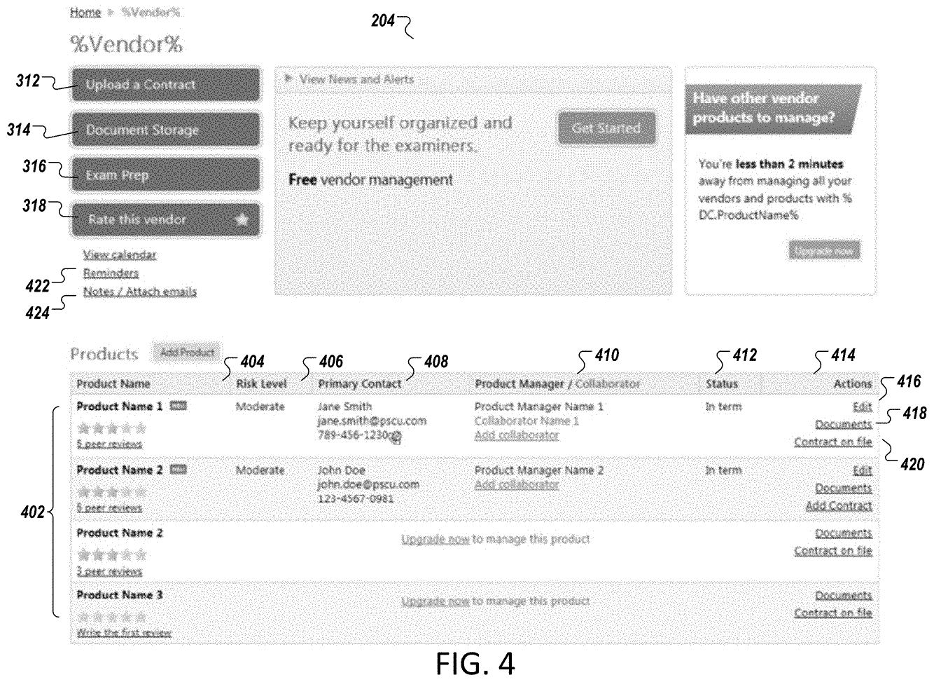

FIG. 4 is an example vendor dashboard 204 in accordance with an embodiment of the invention. In some implementations, the vendor dashboard 204 may be accessed by the end-user when the user selects a vendor from the list of vendors 302 in the main dashboard 202.

In some implementations, the vendor dashboard 204 may include the function to upload a contract associated with a given product (312), the function to manage stored documents (314), the function to prepare for an examination (316), and the function to view and manage reviews for a given vendor products (318).

In some implementations, the vendor dashboard 204 may include a list of vendor products (402) that are associated to the financial institution. The list 402 may include, for example, but not limited to, products that are currently being managed as well as products that are yet to be assigned to a given product manager. For each of the products in the list 402, the system 100 may display a product name 404, a risk level that has been assigned to the product 406, a vendor contact information 408, an assigned product manager (of the financial institution) 410, a status indicator of the product 412, and actionable tasks 414 associated with a given product. The actionable tasks 414 may allow an end-user to edit a given product information (416), to view or manage the document associated with the given product (418), and to add a contract or edit the contract on file associated with the given product (420).

Upon a selection of a product in the list 402, the system 100 may prompt the end-user whether to assign a product-manager for the product. The prompt may further include details and information about the product, including, for example, the vendor name, the product name, the product type, and the source of the product. Upon the end user providing the information, the system 100 may provide options to allow the end-user to upload a contract, to add a collaborator, or to add contact information.

Upon a selection to edit a product (416), the system 100 may display the information about an added product (e.g., the vendor name, the product name, the product type, and a risk level), as described in FIG. 3. The system 100 may also display the vendor's contact-information and/or a list of assigned collaborators.

The system 100 may provide a selection to allow the end-user to remove collaborators from specific products.

Upon a selection to edit a contract (420) associated with a product, the system 100 may display information relating to the contract, including the status of the contract (e.g., “in-term”, “renewal negotiation”, “auto-renew”, “cancelled”, “replaced”, etc.), the contract files (which may include one or more files), the end-user that uploaded the contract, the upload date, the contract date, the contract expiration date, a list of products associated with the contract, and certain key clauses (e.g., whether the contract includes an auto-renewal clause, information relating to the number of days required for a non-renewal notice, and an auto-renewal period). The system 100 may also display information relating to the contract terms (e.g., sale price per unit, etc.), comments associated with the term (e.g., whether the contract is a service-level agreement (SLA)), the vendor signatory, the institution signatory, among others. The system 100 may provide a prompt to the end-user to edit or replace the contract.

In addition, the system 100 may take actions and set reminders. Example actions of the system 100 are summarized in Table 1.

TABLE 1

| Status | Description | Action | Email Communication |
|---|---|---|---|
| In Term | Contract has not reach | No action taken | Initiate communication |
| | expiration date | | six months from |
| | | | expiration date |
| Renewal | Financial Institution is | No action taken | Sent on the expiration |
| negotiation | working on a new contract | | date |
| | terms | | |
| Auto- | Automatically renew terms | Change the contract | Sent on the expiration |
| Renew | of the contract based on the | expiration date based | date |
| | info entered when the | on the terms loaded in | |
| | contract was loaded | the upload contract | |
| | | form | |
| Cancelled | Contract is no longer valid | All products/ | Sent on the expiration |
| | | documents associated | date |
| | | with the contract will | |
| | | also be in cancelled | |
| | | status and archived | |
| Replace | Financial Institution | Move old contract to | |
| | replacing the existing | archives/new | |
| | contract with a new one | contract starts the | |
| | | upload contract | |
| | | process over | |

In addition, upon a selection to edit a contract, the system 100 may provide guidance to the end-user depending on the various selected options. For example, if the end-user specifies “renewal negotiation” (which indicates that the end-user is currently negotiating the contract with the vendor), the system 100 may provide a message that states: “By setting a contract to renewal-negotiation, you will no longer receive notices regarding contract expiration and/or auto-renewal. Change your status when you are ready. You can either upload your new contract or cancel your existing contract.” The system 100 may also take action, such as to stop the sending of the contract expiration emails.

In another example, if the end-user specifies “auto-renew” (which indicates that the contract would auto-renew with the terms as originally provided), the system 100 may prompt the end-user for a new expiration date for the contract and a date for new reminders.

In yet another example, if the end-user specifies “cancelled” (which indicates that the contract has been canceled), the system 100 may notify the end-user that the system 100 will cancel all of the selected products, archive all of the uploaded documents, and archive all of the uploaded contracts. The system 100 may also prompt the end-user for new vendor information. The system 100 may also prompt the end-user to upload a new contract or document.

In yet another example, if the end-user specifies “replace contract” (which indicates that the end-user wishes to replace an existing contract with a new contract), the system 100 may prompt the end-user for new documents associated with the new contact. The system 100 may archive the old contract in an archived folder. The old contract may be accessible to the end-user at the document storage page 206. In some implementations, the system 100 may also sent the new document to the third-party 218 for analysis and preparation.

Still looking at FIG. 4, the vendor dashboard 204 may include features to assist the end-user in managing reminders and notes associated with the vendor product. For example, the vendor dashboard 204 may include an option to display all of the reminders (422) associated with a given vendor.

The vendor dashboard 204 may include an option to attach and view notes and correspondences (424) (e.g. electronic mail) associated with the vendor. In some implementations, the system 100 may present the information as a list that includes the dates that the note was created, a title for the note, a note type, a product name, an identifier of the end-user that created the note, a vendor name, a product name, and a note message. The list may be filed, sorted, or organized using the note title, the email information, or by the product information.

Document Storage

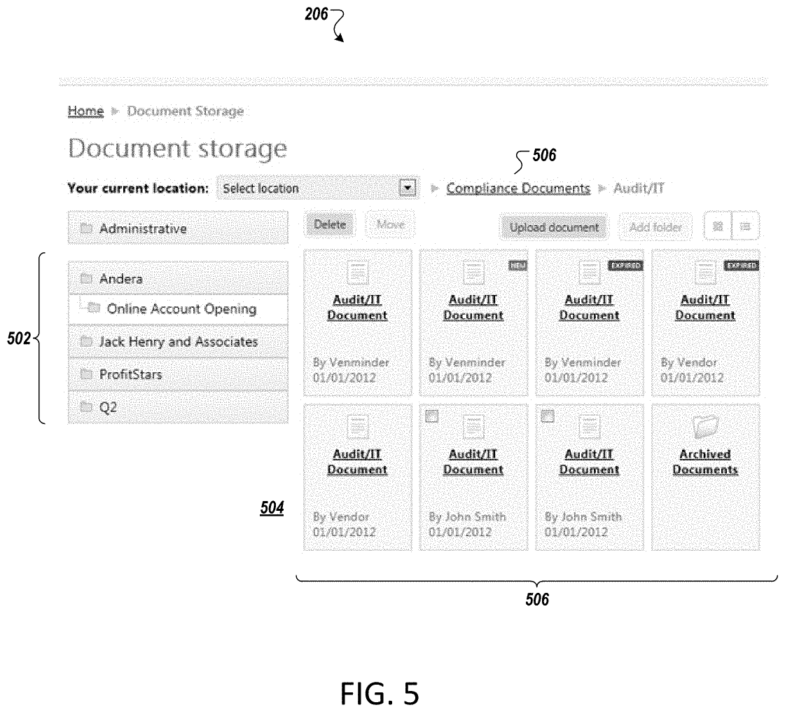

FIG. 5 is an example document storage page 206 in accordance with an embodiment of the invention. The document storage page 206 allows an end-user or product manager to view and manage documents associated with a given vendor.

In some implementations, the document storage page 206 may display a list of product managers 502 and the documents they are managing or collecting. The document storage page 206 may include a workspace 504 for managing and viewing a set of collected documents. The workspace 504 may allow the end-user to organize the set of documents in a set of vendor folders. The vendor folders may include documents and folders associated to a given vendor and vendor product.

In some implementations, the document storage page 206 may include a compliance document folder 506 to be used for the examination preparation effort. The compliance document folder 506 may include folders relating, for example, to “audit/IT”, “business continuity”, “financial”, “insurance”, “miscellaneous”, “policy”, and “product management.”

Upon a selection to upload a new document, the document storage page 206 may prompt the end-user for a file to upload, a document description, a document date, comments, and/or reminders.

The document storage page 206 may restrict the transfer of files. In some implementations, once a document has been uploaded, for example, to the compliance document folder 506, the document storage page 206 may prohibit the end-user from moving these documents to a different folder. To this end, the system 100 may require the end-user to delete the file and re-upload the file to the different folder. In some implementations, the document storage page 206 prohibits the addition of new folders to the compliance document folder 506.

As another example, only documents uploaded by the end-user may be moved by the end-user. The document storage page 206 may indicate to the end-user the documents that they have permission to move. The document storage page 206 may indicate the owner of the document.

The document storage page 206 may label the various uploaded documents. For example, in some implementations, the document storage page 206 may label documents that have been newly uploaded by the third-party 218 or by the vendor as “new”. The label may appear only during a first login session by the end-user, and the label may be removed in subsequent sessions. Other labels may include “expired.”

Exam Preparation

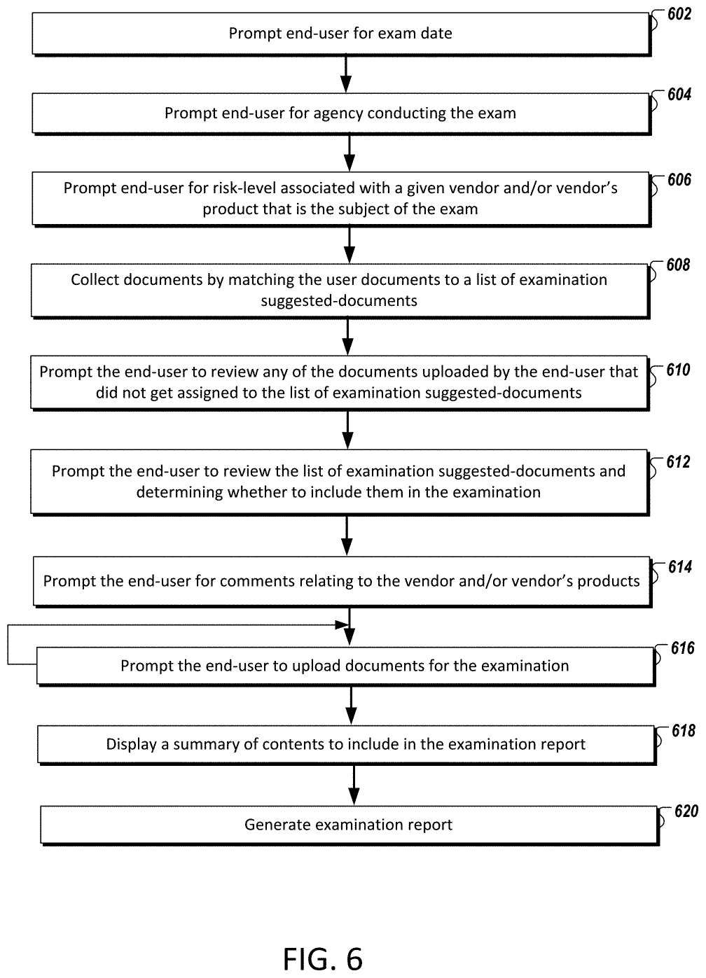

FIG. 6 is an example workflow of the system 100 to guide an end-user to prepare a vendor oversight report associated with one or more selected vendor products in accordance with an embodiment of the invention. The workflow may be referred to as “Exam Prep”. The Exam Prep may be used to assist and guide the users of a financial institutions to prepare, for example, for its annual exam with a given government agency, regulatory body, or auditing process. In some implementations, the Exam Prep may collect all of the documents that will be the subject of the examination. The Exam Prep may collect all of the notes and correspondences associated with a product. The Exam Prep may allow the end-user to review all of these documents. The Exam Prep may allow end-users to invite experts and/or collaborators to assist with the exam preparation. The Exam Prep may create or generate a report for the examiners.

In some implementations, the Exam Prep workflow may be initiated from the main dashboard 202 or the vendor dashboard 204, as described in relation to FIGS. 3 and 4.

Upon initiation of the Exam Prep workflow, the system 100 may prompt the end-user for examination information, including, for example, a date of the next regulatory exam (step 602). The system 100 may use the provided date to track the number of days remaining until the examination and to determine when notification (e.g., by email) regarding the examination may be sent. In some implementations, the system 100 may send, for example, a reminder to an end-user that created the report (and/or the product manager) 90 days before the examination. The reminder may indicate to the end-user that the report is ready for the end-user's review. The system 100 may also send a reminder, when no report has been generated, to an end-user to remind them to start a report.

In the Exam Prep workflow, in some implementations, the system 100 may prompt the user for a list of one or more agencies to be included in the examination (step 604). Examples of the agencies may include, for example, but not limited to, the Consumer Financial Protection Bureau (CFPB), Federal Deposit Insurance Corporation (FDIC), Federal Reserve System (FED), National Credit Union Administration (NCUA), and/or the Office of the Comptroller of the Currency (OCC).

In some implementations, the system 100 may also prompt the end-user for a risk-level (e.g., low, medium, high, and undefined/unknown) associated with the vendor and/or vendor product, if the information has not been provided, for which the examination is being prepared (step 606). The risk-level may be an input from the risk-assessment module 214. The system 100 may use the provided risk-level to determine suggested documents for the examination-preparation process.

FIG. 7 is an example vendor examination-preparation workspace 700 in accordance with an embodiment of the invention. The workspace 700 may display a list of products 702. For each of the products 702, the workspace 700 may display the vendor name (704), the status of the examination (706), the last reported date (708), and actionable tasks 710.

The last reported date 708 may be, for example, the last time a report was created or the last time the product was examined. The status of the examination (706) may include “complete”, “in progress”, and “not started.” A list of the examination status is shown in Table 2.

TABLE 2

| Status | Description | Action |
|---|---|---|
| Complete | All steps have been completed | Review, Preview report |
| In progress | Started but not all steps completed | Continue, Preview report |
| Not started | No steps have been started | Start |

The actionable tasks 710 may include reviewing an examination report (712), creating a report (714), continuing a report (716), and starting a report (718).

The system 100 may save all of the work, including all of the actions taken by the end-user. To this end, the end-user can continue from another point in the examination preparation process.

Referring back to FIG. 6, in some implementations, the method 600 may include matching all of the end-user's uploaded documents to a list of examination suggested documents (step 608). The list of examination suggested documents may be a pre-defined list selected from a set of pre-defined list. The pre-defined list may be selected based on the risk-level associated with the given product or vendor subject to the examination.

FIG. 8 is an example workspace 800 for matching collected end-user's document to a list of suggested documents in accordance with an embodiment of the invention. The workspace 800 may display a list of collected documents uploaded by the end-user (802). The list may include documents collected in the compliance document folder, as described in relation to FIG. 5. The workspace 800 may display a list of suggested documents (804) for the examination. The list of suggested documents (804) may be a pre-defined list of documents that is organized by risk levels. The workspace 800 may allow the end-user to select a document from the collected list (802) and “drag and drop” it to a suggested content in the list of suggested documents (804). The action may merely associate the documents in that no files are moved.

The system 100 may display a status of the workflow (806). The status may include an indicia of the current process being performed by the end-user and a status of the other processes (e.g., complete, in-profess, or ready to start) in the workflow.

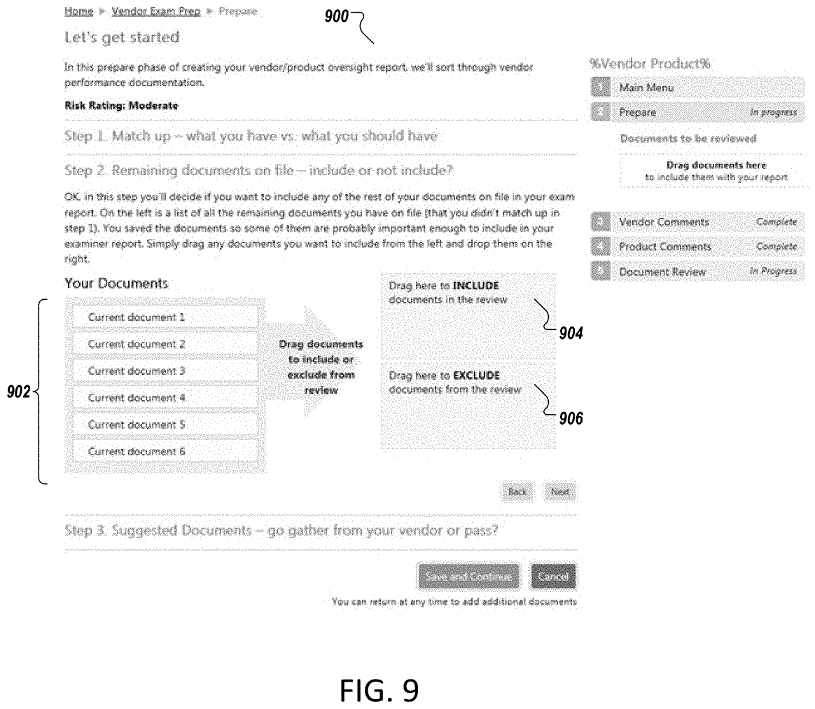

Referring back to FIG. 6, in some implementations, the method 600 may include prompting the end-user to review any of the collected documents uploaded by the end-user that was not assigned to the list of the examination suggested-documents (step 610). FIG. 9 is an example workspace 900 for prompting the end-user to review the unassigned documents 902 that has been collected to the document storage page 206, but has not been assigned in FIG. 8. In some implementations, the system 100 may prompt the end-user to identify each of the unassigned documents as either to include (904) or exclude (906) from the report/examination.

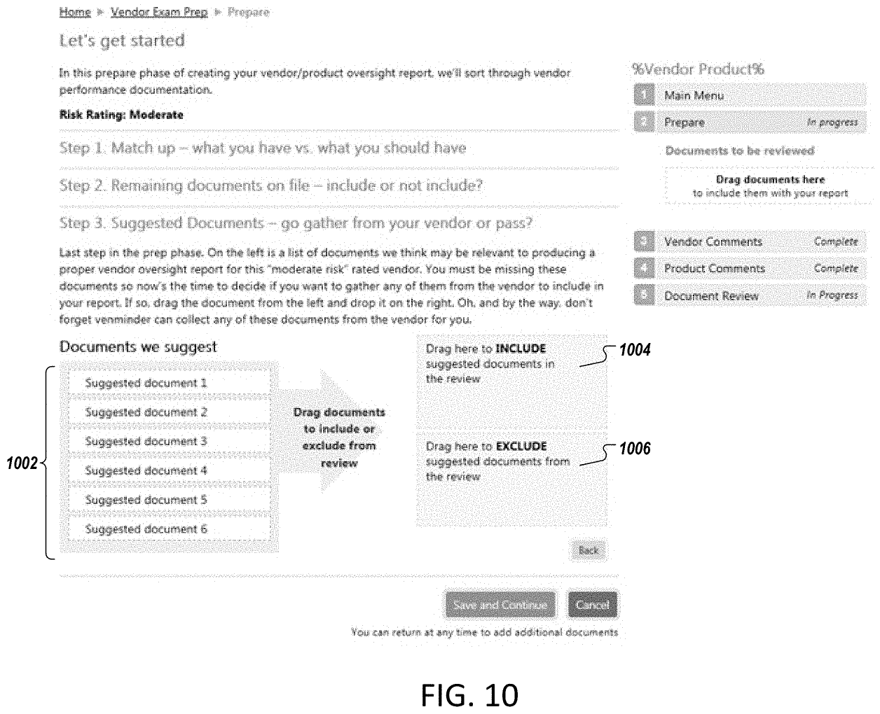

Still looking at FIG. 6, in some implementations, the method 600 may include prompting the end-user to review the list of examination suggested-documents and determining whether to include them in the examination (step 612). FIG. 10 is an example workspace 1000 for prompting the end-user to review the unassigned suggested documents 1002. The system 100 may prompt the end-user to identify each of the unassigned suggested documents as either to include (1004) or exclude (1006) from the report/examination.

Still looking at FIG. 6, in some implementations, the method 600 may include prompting the end-user to provide comments about the vendor (step 614). The comments may be in response to interrogatories, such as (i) “What has the vendor done well since your last exam date,” (ii) “What has not gone well since your exam date,” and (iii) “What actions are you going to take before your exam date.” The system 100 may also prompt the user to provide comments for each of the vendor product that is being examined.

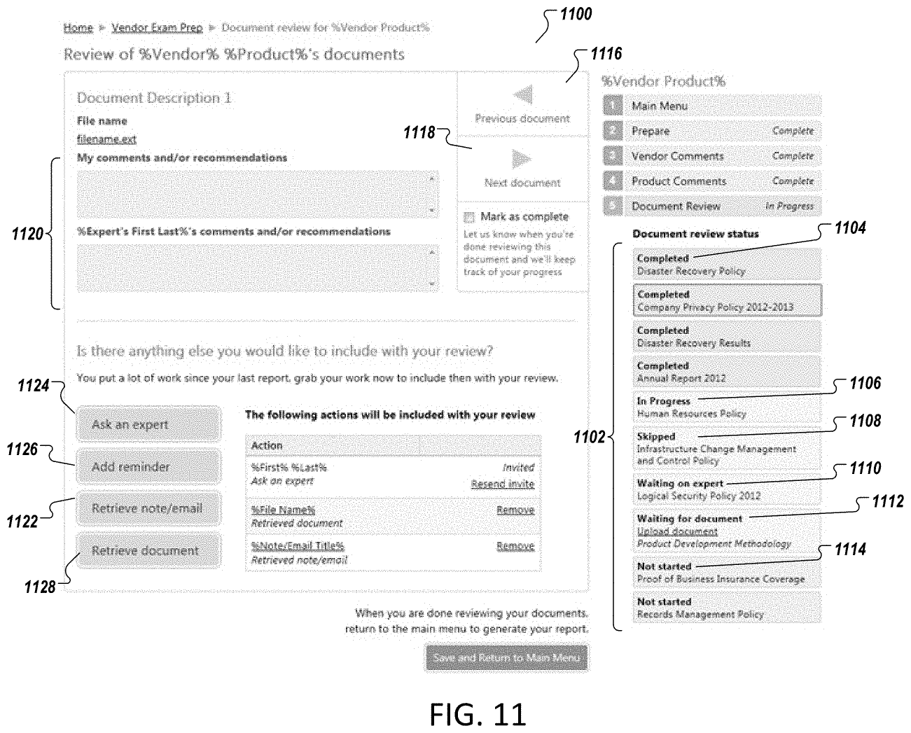

Still looking at FIG. 6, in some implementations, the method 600 may include displaying (step 614) all of the documents that has been matched between the end-user's uploaded documents and the list of suggested documents (as described in relation to FIG. 8) as well as those documents that are marked to include (as described in relation to FIGS. 9 and 10). FIG. 11 is an example workspace 1100 for preparing the collected document for the examination report in accordance with an embodiment of the invention. The system 100 may display a status label for each of the documents. The status label may include “completed” 1104, “in progress” 1106, “skipped” 1108, “waiting for experts” 1110, “waiting for documents” 1112, and “not started” 1114. The status labels are described in further detail in table 3.

TABLE 3

| Document Status-Label | Description |
|---|---|
| Not Started | Included in exam but the user has not reviewed it |
| Waiting on expert | Expert has been invited but no response provided |
| Waiting for documents | Document type is included in exam but document has not |
| | been uploaded |
| Skipped | Viewed the document but preformed no actions |
| In Progress | Actions preformed but not marked as complete |
| Complete | Checked the box mark as complete |

In some implementations, the system 100 may provide a navigation function to allow the end-user to scroll through the various selected documents. The navigation function may include an arrow to review the previous selected document (1116) or the next selected document (1118). For each of the selected documents, the system 100 may allow the end-user to add comments (1120), to retrieve an electronic correspondence or note (1122), to invite an expert and/or collaborator to provide comments or to assist in the document preparation (1124), and/or to set reminders (1126).

Upon selection to invite a co-worker/expert (1124), the system 100 may provide a list of co-workers and/or suggested experts for the user to send a message. The system 100 may also prompt the end-user for a name, contact information, and a message to send to a co-worker and/or expert. The system 100 may accept multiple requests for comments.

The system 100 may allow each of the co-workers and/or experts to register and login. After which, the system 100 may only allow the co-worker and/or expert to view and provide comments for the vendors and/or vendor product to which they were asked for comments. The system 100 may send a notification to the end-user subsequent to a comment being provided. The system 100 may also send a notification when the co-worker and/or expert has registered to the system 100.

Upon receipt of comments from a given co-worker and/or expert, the system 100 may label the request as being complete. The system 100 may also update the Exam Prep workspace 1100 with the received solicited comments. To this end, the system 100 may provide an organized and efficient framework to request for comments from internal and external collaborators, to track such requests, and to review and utilize such comments in the examination-preparation process.

Upon selection of an input to retrieve an electronic correspondence or note (1122), the system 100 may display a list of notes and correspondences stored within the system 100. The system 100 may provide a date, a title, a correspondence type (e.g., email, notes, SMS, etc.), and an identity of the end-user and/or product manager that performed the uploaded. The system 100 may allow the end-user to filter the list based on the correspondence type.

Still looking at FIG. 11, the system 100 may allow the end-user to retrieve additional documents (1128) related to the vendor product. A selection of this input (1128) may direct the end-user to the document storage page 206, as described and shown in relation to FIG. 5. The end-user may add documents to the examination preparation process from there.

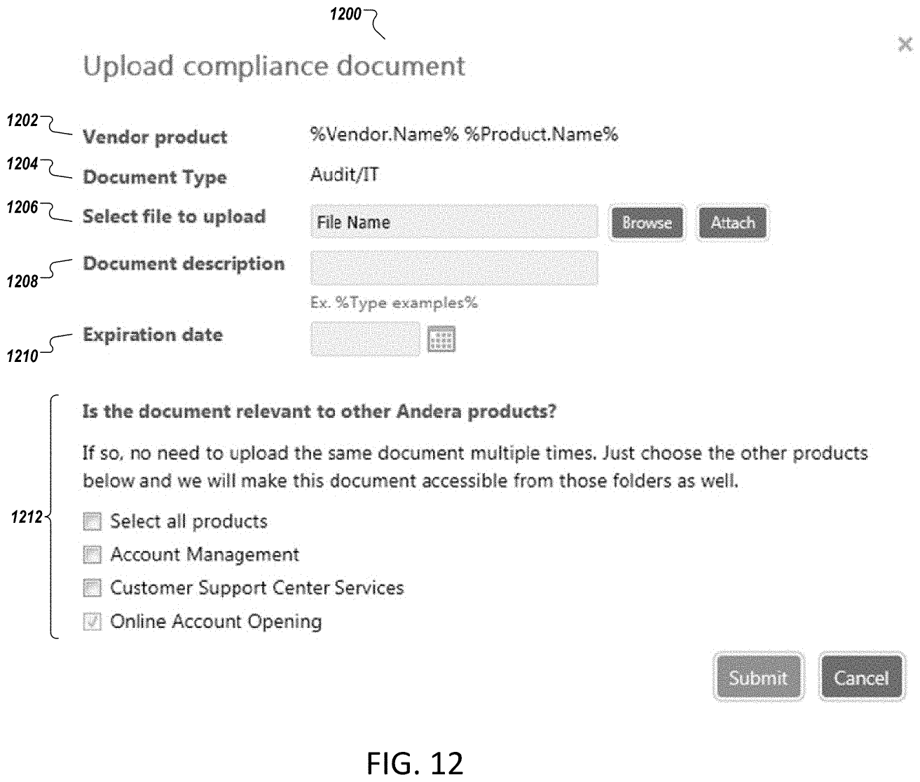

Referring back to FIG. 6, in some implementations, the method 600 may include prompting the end-user to upload documents for the examination (step 616). FIG. 12 is an example workspace 1200 for uploading document to be attached and included in the examination in accordance with an embodiment of the invention. The workspace 1200 may display the vendor product name 1202 and the document type 1204. The workspace 1200 may prompt the end-user for a file (1206), a document description (1208), an expiration date (1210), and a selection to use the document for other products (1212). The selection (1212) allows the end-user to have to upload a given document only once as the document can be applied to multiple products that may be the subject of one or more examinations. The workspace 1200 also allows the end-user to tailor comments and descriptions for each of the documents to be included in the report.

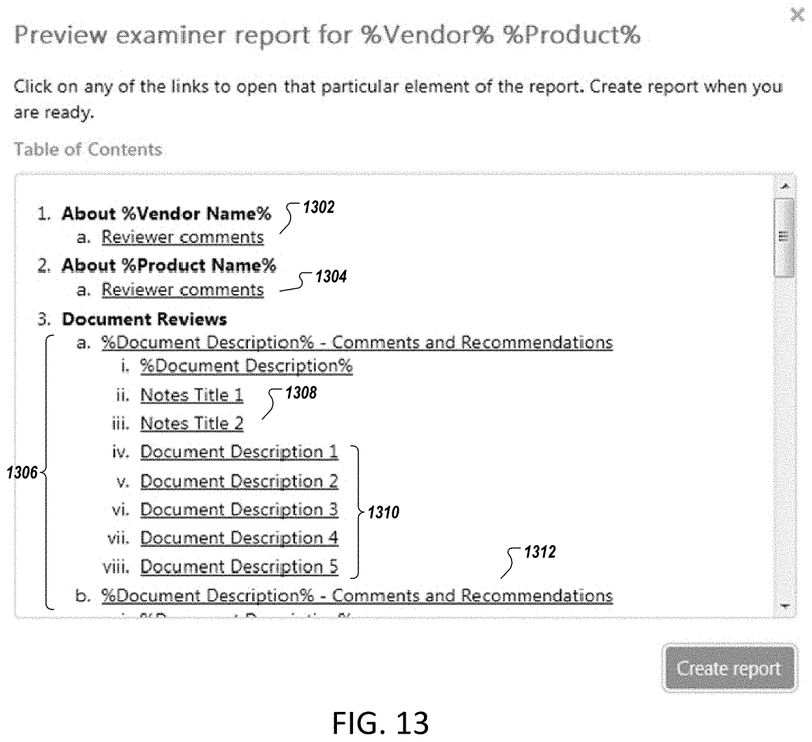

Still looking at FIG. 6, in some implementations, the method 600 may include displaying a summary of contents to include in the examination report (step 618). FIG. 13 is an example workspace 1300 to preview contents to be included in the examination report. The contents may include, for example, but not limited to, the reviewer's comments about the vendor (1302), the reviewer's comments about the products (1304), and the documents to include in the report (1306). The documents 1306 may include notes (1308), documents (1310), and comments and recommendations (1312). The system 100 may allow the end-user to preview any of the uploaded documents, comments, and notes as collected by the system 100.

Still looking at FIG. 6, in some implementations, the method 600 may include generating an examination report in accordance with an embodiment of the invention (step 620). The report may be generated, for example, as a PDF (“portable document format”) file. In some implementations, the report may be generated as a compressed file (e.g., a ZIP (archive file format) file). Upon a creation of the examination report, the system 100 may add the report to an archive section to which the end-user can later review the report. The system 100 may also update the vendor and product dashboard to indicate the recent addition of a new report as well as the status of the last instance that a report had been created. In some implementations, the system 100 may send a notification to the end-user to recommend initiating a new report (in the case of an annual report). The notification may be sent, for example, 9 months after the examination report has been generated.

Vendor Product Review

The system 100 may include a vendor product review workspace to allow the end-user to view and provide reviews/ratings for a given vendor, as described in relation to FIG. 3. In some implementations, the system 100 may display the performance rating and/or the listing of one or more performance comments received from users of the given vendor product and/or one or more corresponding products provided by one or more different vendors.

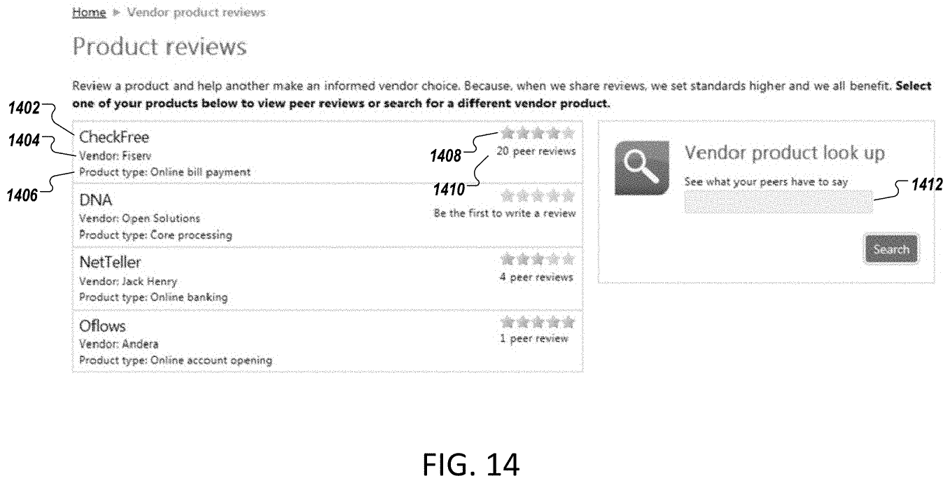

FIG. 14 is an example workspace 1400 to review vendor products in accordance with an embodiment of the invention. The workspace 1400 may display, at any given instance, a composite of multiple vendor products. The composite may include preferably four to five vendor products. Of course, any of number of vendor products may be displayed on the workspace 1400. For each of the products, the workspace 1400 may display the vendor name (1402), the product (1404), the product type (1406), a rating value 1408, and an indication of the number of reviews (1410). In some implementations, the system 100 may provide a search tool 1412. In some implementations, the system 100 may also provide a rating/review module for a given vendor.

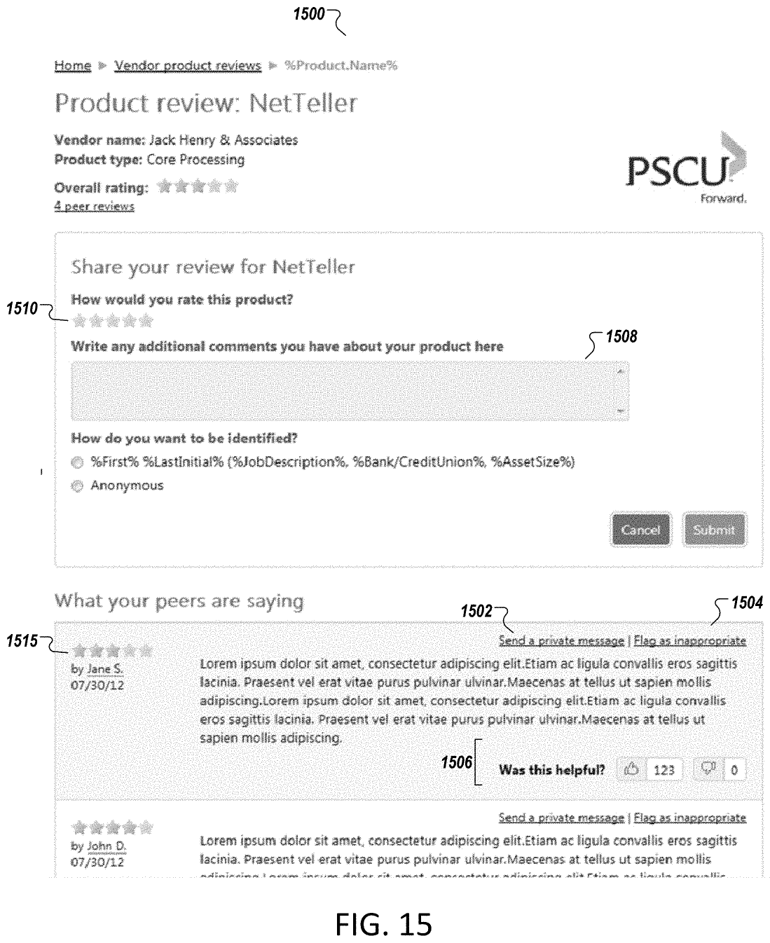

FIG. 15 is an example display 1500 for viewing product reviews in accordance with an embodiment of the invention. In some implementations, the system 100 may provide a prompt 1502 for the end-user to send a private message to the vendor or to the reviewer. The system 100 may also provide a prompt 1504 to flag the review as being inappropriate. The flag may generate a notification to a designated reviewer to determine whether the message is appropriate to display. The system 100 may also display an indicator of the number of people that flagged the review as being helpful and/or unhelpful.

The system 100 may prompt the end-user to provide a review 1508 for a given selected product. The end-user may provide a rating value 1510 (which may a star rating), comments, and identifier/contact information.

In some implementations, the display 1500 may include a listing of performance ratings (1512) received from various end-users and/or product managers of the various vendor products. The listing may be organized (e.g., ordered) on the graphical user interface according to popularity (e.g., number of “likes” received for each of the performance comments).

News and Alerts

The system 100 may include an alert and/or information feed that provides information about changes that have been made (e.g., new documents uploaded, new reviews added, and status updates for a given examination or preparation process, etc.). The alert may include a progress bar to indicate a given end-user progress with a given task.

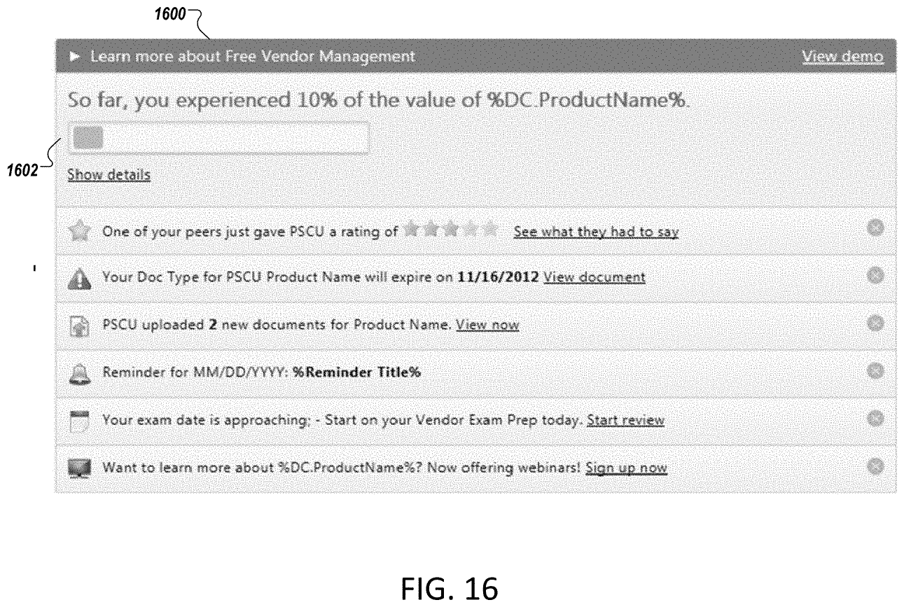

FIG. 16 is an example alert and information display 1600 in accordance with an embodiment of the invention. The display 1600 may include an experience bar 1602 that shows a given user's level of experience with the system 100. The system 100 may calculate the experience bar based on a set of tasks or functions performed by the end-user within the system 100. Each function may be assigned a function value, which may be aggregated to produce a total experience value. The experience bar 1602 may display the total experience value to the user. Examples of assigned values for a set of functions are provided in Table 4.

TABLE 4

| Function | Link | Percentage |
|---|---|---|
| Add Contract | Upload Contract | 10% |
| Add 2 Compliance Documents | Document Storage | 5% each |
| Add a vendor product | Add Vendor Product | 10% |
| Add a collaborator | Vendor Dashboard | 10% |
| Attach an email and Note | Emails and Notes | 5% each |
| Add a reminder | Reminders | 10% |
| Preform Exam Prep | Exam Prep | 20% |
| Write a review | Vendor Product Review | 10% |

SLA Module

In another aspect of an embodiment, the system 100 provides a Service Level Agreements (SLA) module as described herein, which allows for contractual agreements between a user (e.g., a client user) and one or more third party vendors to be setup, recorded, remediated, and managed. Users (e.g., client users) whose purchase plan specifies the Service Level Agreements software may have access to the module. The Service Level Agreements module allows users of the system to organize their SLA needs in one system to help align with their current vendor management practices.

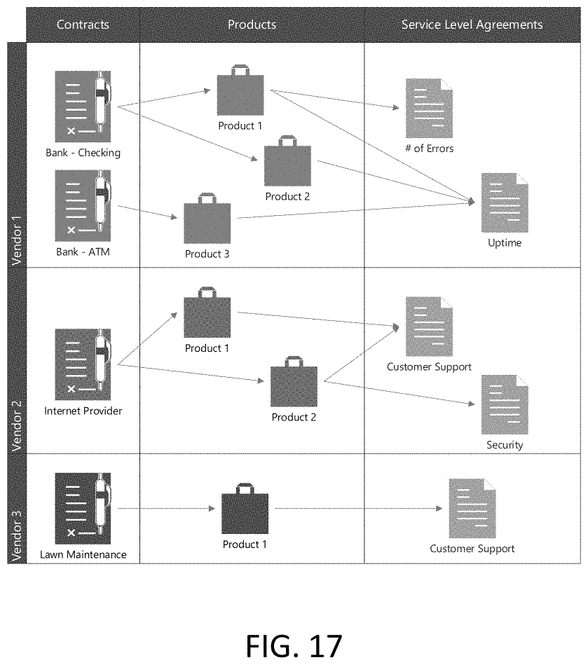

Service Level Agreements are managed in a product-based manner in the system application. Within the SLA application (e.g., within one or more databases associated with the application), the SLAs (e.g., in form of electronic documents stored in one or more databases) are linked to products (e.g., in form of electronic database information), which are linked to contracts (e.g., in form of electronic documents stored in one or more databases). In some embodiments, there is no direct link from the SLAs to contracts as an SLA can be shared across products, e.g., as shown in FIG. 17.

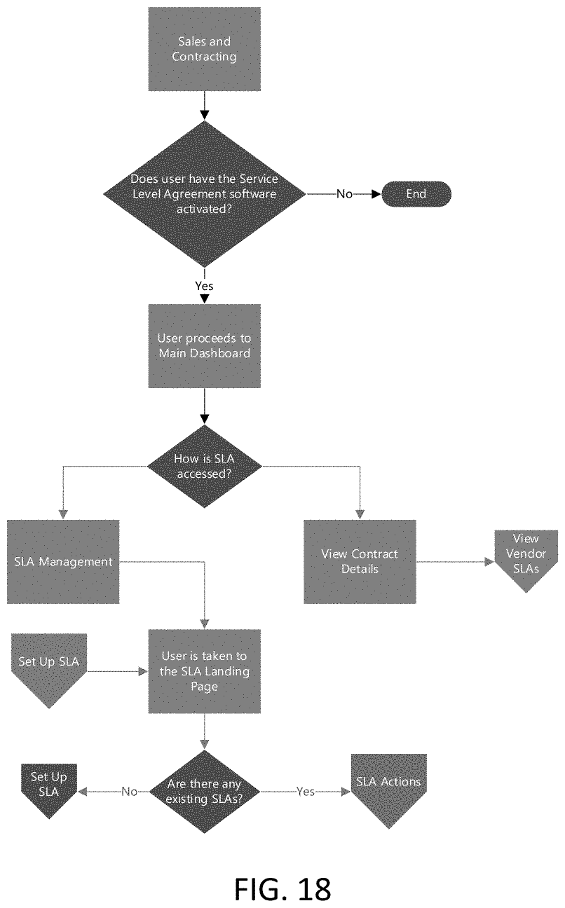

Basic workflow of an example SLA module is shown in FIGS. 18-21. In some embodiments, example SLA modules can be accessed as shown in FIG. 18. A user may (first) access a sales and contracting module, e.g., of a system administrator. If it is determined that the user has access to an (active) SLA module, the user may be allowed to proceed to a main dashboard (e.g., an SLA main dashboard). Access to a main dashboard (e.g., an SLA main dashboard) may be managed (e.g., denied or granted) automatically by a processor accessing user subscription data in a database and denying or granting access based on the user subscription data. In some embodiments, a user may access an SLA management module (e.g., an SLA management GUI), which may include or be connected to an SLA landing page (e.g., an SLA landing page GUI). In some embodiments, an SLA landing page may be accessed by a set up SLA command (e.g., through a widget). From an SLA landing page, a user may take actions including setting up new SLAs or manage existing SLAs. In some embodiments, one or more SLAs can be accessed through a view contract details module (e.g., a module (GUI) allowing viewing and managing main contracts between financial institution and one or more vendors).

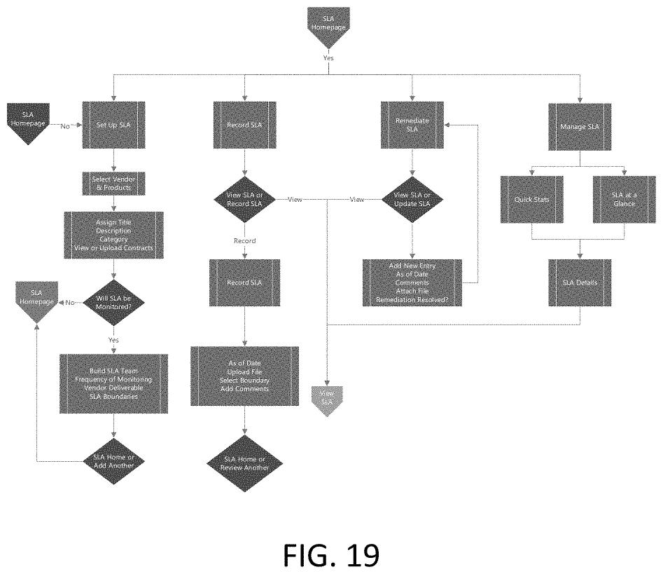

An example workflow departing at an SLA home page (e.g., SLA landing page) is shown in FIG. 19. In some embodiments, a user may set up a new SLA, e.g., through a set up SLA module (e.g., set up SLA GUI). From the set up SLA module, a user may select (e.g., via a GUI) one or more vendors or products to which one or more SLAs may be linked (e.g., SLA related data in a database may be linked to vendor and/or product data in the same database or a different database). A user may then be provided with a module (e.g., a GUI) to assign a title, provide description, and/or category information related to one or more SLAs. In some embodiments, a user may view and/or upload contract files, e.g., via a GUI or widget. A user may select if one or more SLAs will be monitored, e.g., via input on the set up SLA GUI. If monitoring is requested, a user may be provided with a module (e.g., a GUI) configured to receive input information related to the assembly of an SLA team, frequency of monitoring, vendor deliverable, and/or SLA boundaries. Once this process is complete, a user may be taken back (e.g., automatically, by a processor) to the SLA home page or may be prompted (automatically) with a GUI to select addition of a new SLA. If monitoring is not selected or if monitoring is declined (e.g., via input on a GUI), a user may remain or be taken back to the SLA home page.

In some embodiments, a user departing from a an SLA home page (e.g., SLA landing page) can select a record SLA module (e.g., a record SLA GUI). From the record SLA module, a user can select to either view an existing SLA or to record an SLA. If recording an SLA is selected (e.g., via a GUI), a user may be provided with a GUI to provide record information (e.g., as of date, boundaries, and/or comments) and/or to upload a file. Once this process is complete, a user may be taken back (e.g., automatically, by a processor) to the SLA home page or may be prompted with a GUI to select review of another SLA.

In some embodiments, a user departing from a an SLA home page (e.g., SLA landing page) may select a remediate SLA module (e.g., a remediate SLA GUI). From the record SLA module, a user may select to either view an existing SLA or to update an SLA. If updating an SLA is selected (e.g., via a GUI), a user may be provided with a GUI to provide remediation information (e.g., add a new entry, as of date, comments, and/or question relating to resolution of a remediation) and/or to upload a file.

In some embodiments, a user departing from a an SLA home page (e.g., SLA landing page) may select a manage SLA module (e.g., a manage SLA GUI). From the manage SLA module, a user may select a quick stats module (e.g., a quick stats GUI) and/or an SLA at a glance module (e.g., a SLA at a glance GUI), e.g., to review and/or manage SLA information. From the quick stats module and/or the SLA at a glance module, a user may access an SLA details module (e.g., an SLA details GUI). In some embodiments, a user may access the view SLA module from the SLA details module.

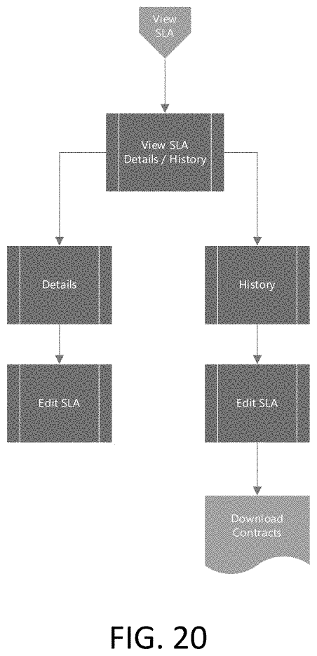

An example workflow departing from a view SLA module is shown in FIG. 20. In some embodiments, a user may view SLA details and/or history, e.g., via a GUI (e.g., a view SLA GUI). A user may select to view SLA details (e.g., via a details GUI). In some embodiments, a user may edit one or more SLAs in the details GUI or in a GUI linked to the details GUI. A user may select to view SLA history (e.g., via a history GUI). In some embodiments, a user may edit one or more SLAs in the history GUI or in a GUI linked to the history GUI. In some embodiments a user may be provided with a GUI or widget (e.g., on or linked to an edit SLA GUI) to download one or more contracts.

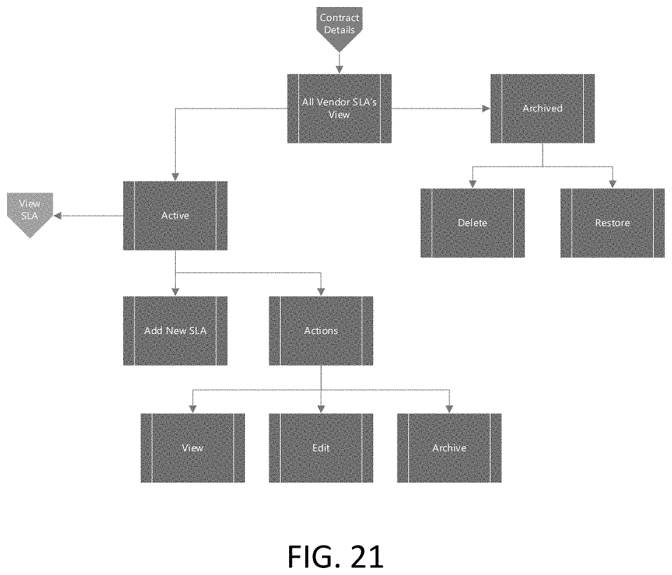

An example workflow departing from a view contract details module is shown in FIG. 21. In some embodiments, a user may view all vendor SLAs, e.g., via a GUI (e.g., a contract details GUI). A user may select, e.g., via a GUI, to view archived contract information, e.g., on an archived GUI or widget. On the archived GUI or widget, a user may select one or more archived contracts and provide a command to, e.g., either delete or restore one or more archived contracts. A user may select, e.g., via a GUI, to view active contract information, e.g., on an active GUI or widget. A user may view an SLA (e.g., via a view SLA GUI) or may add a new SLA (e.g., via an add new SLA GUI). A user may take action on an SLA (e.g., via an actions GUI), e.g., to view, edit, and/or archive one or more SLAs (e.g., via one or more view, edit, and/or archive GUIs)

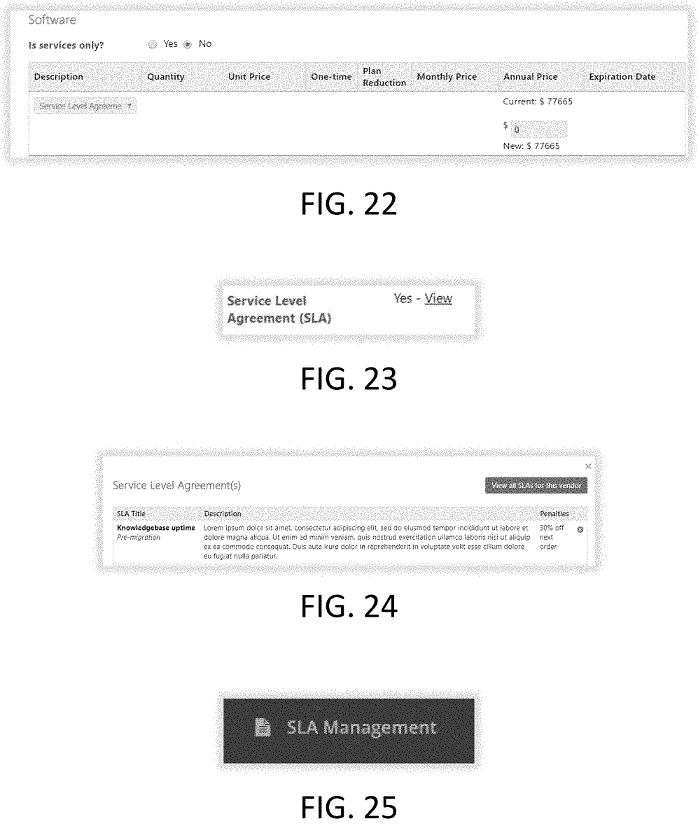

An SLA module may be included in system 100 and may be accessible at the outset (e.g., when system 100 is first installed and/or accessed by a user) or may be added later. In some embodiments, system 100 may include a main dashboard 202 for managing actions associated with a given vendor 104 and/or may include a vendor dashboard 204 to view and manage products and vendors associated with a given financial institution. A system 100 may include one or more sales and contracting workspaces, e.g., linked to main dashboard 202 and/or vendor dashboard 204. A system provider, e.g., a provider user, can manage a client's service level agreement software through the sales and contracting module in the system/provider application. When the service level agreement software is ordered, a user (e.g., a user in the provider sales team) can indicate the annual price paid for the software. FIG. 22 is an example software setting workspace in accordance with an embodiment of the invention. In some embodiments, if the service level agreement is selected in the description and the annual price is populated, then a client user may have access to the service level agreement software and its associated modules and GUIs.

Contract Details Entry

In some embodiments, a user, e.g., an administrator user of a system provider, may access the SLA module through a contract details entry feature (e.g., a contract details entry workspace). An administrator user may locate the SLA section on a contract details entry screen or GUI, then select “view”. SLAs are provided in a product-based manner in the system/provider application. Within the application, the SLAs are linked to products, which are linked to contracts, but there is no direct link from the SLAs to contracts as an SLA can be shared across products. In some embodiments, SLAs, products, and/or contracts are stored in separate electronic databases. In some embodiments, SLAs, products, and/or contracts are assigned (e.g., automatically, by a processor) identifiers, e.g., unique identifiers. In some embodiments, unique identifiers may be stored or otherwise linked such that information associated (e.g., stored, accessed, and/or retrieved by a processor) with an SLA may be associated with information associated with one or more products. FIG. 23 is an example SLA indicator workspace displaying contract details view, in accordance with an embodiment of the invention. Selecting “view” may present an SLA modal window or workspace, which provides a view all SLAs for this vendor navigation button. Example view vendor SLAs modules and/or GUIs are described herein. FIG. 24 is an example SLA modal window in a contract details entry workspace, including a view all SLAs for this vendor button, in accordance with an embodiment of the invention.

Client Service Level Agreement Experience

Main Dashboard

In some embodiments, a user (e.g., a client user) may access the service level agreement software by logging into an application, e.g., system 100. Selecting (e.g., by clicking a button or link on a GUI) an SLA management link may direct the user to the SLA landing page. FIG. 25 is an example SLA management selection button, e.g., as displayed on an example main dashboard 202, in accordance with an embodiment of the invention. In some embodiments, a user may need to set up the SLA before beginning any monitoring or recording activities.

SLA at a Glance Widget

In some embodiments, a user (e.g., a client user) may access (e.g., by selecting an appropriate button) a widget on main dashboard 202 designated SLA at a glance. This widget may provide the user with a quick view of three different SLA attributes: status, remediation, and category. Each attribute may be quickly viewed as a graphical representation, along with an option to directly run reports. When a user selects (e.g., clicks a button) to run a report, the user is (automatically) redirected to a system/provider application reporting module. The report that corresponds with the widget view is then loaded. The report is generated automatically by the system, using a default set of filters to display a client user's SLA data. In some embodiments, the following reports may be accessed:

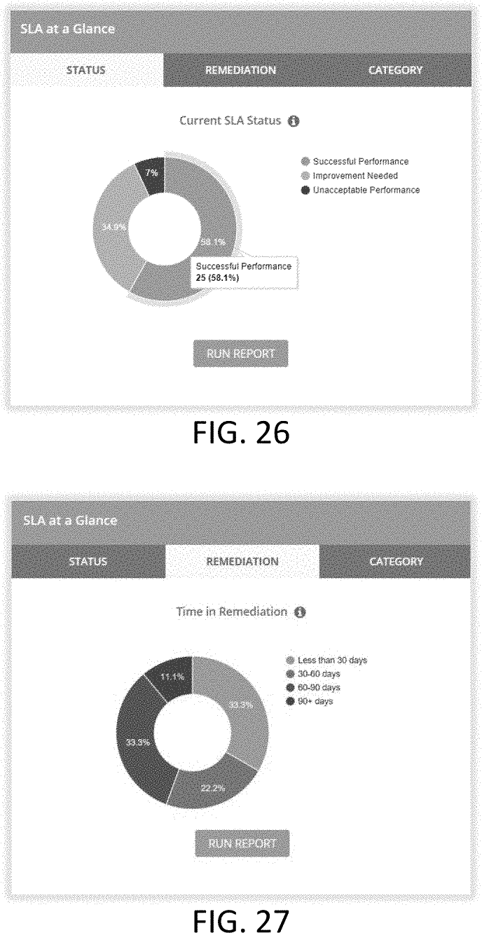

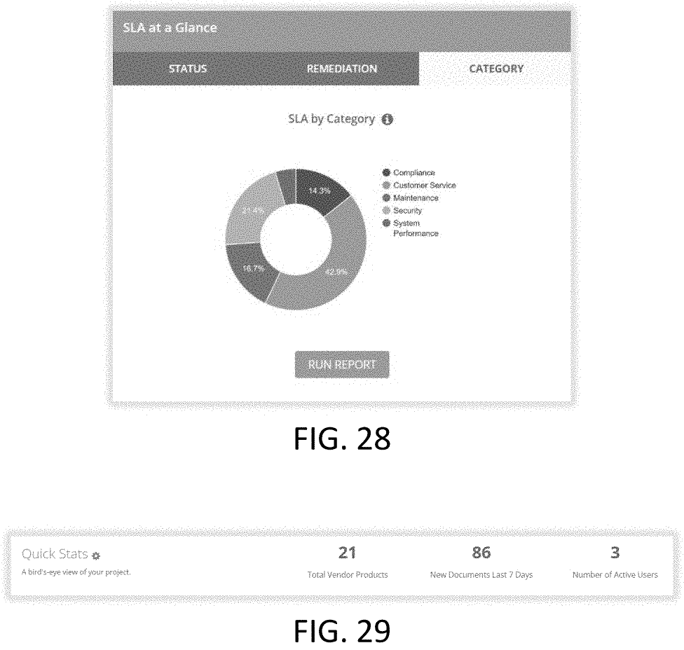

For status, an SLA performance report may be created, e.g., by a processor, e.g., as described herein. FIG. 26 is an example main dashboard—SLA at a glance—status view window, in accordance with an embodiment of the invention. For remediation, an SLA remediation report may be created e.g., by a processor, e.g., as described herein. FIG. 27 is an example main dashboard—SLA at a glance—remediation view window, in accordance with an embodiment of the invention. For category, an SLA Inventory Report may be created. e.g., by a processor, e.g., as described herein. FIG. 28 is an example main dashboard—SLA at a glance—category view window, in accordance with an embodiment of the invention.

Quick Stats

In some embodiments, a user (e.g., a client user) may access (e.g., by selecting an appropriate button) a widget on main dashboard 202 designated quick stats view. FIG. 29 is an example main dashboard—quick stats window, in accordance with an embodiment of the invention. In some embodiments, a main dashboard 202 and/or the quick stats view widget are configurable, e.g., the parameters displayed can be configured by a user. In some embodiments, related SLA settings include total number of SLAs, SLAs being monitored, SLAs past due for monitoring, SLAs in remediation, and/or SLAs with expired cure periods

Service Level Agreement Landing Page

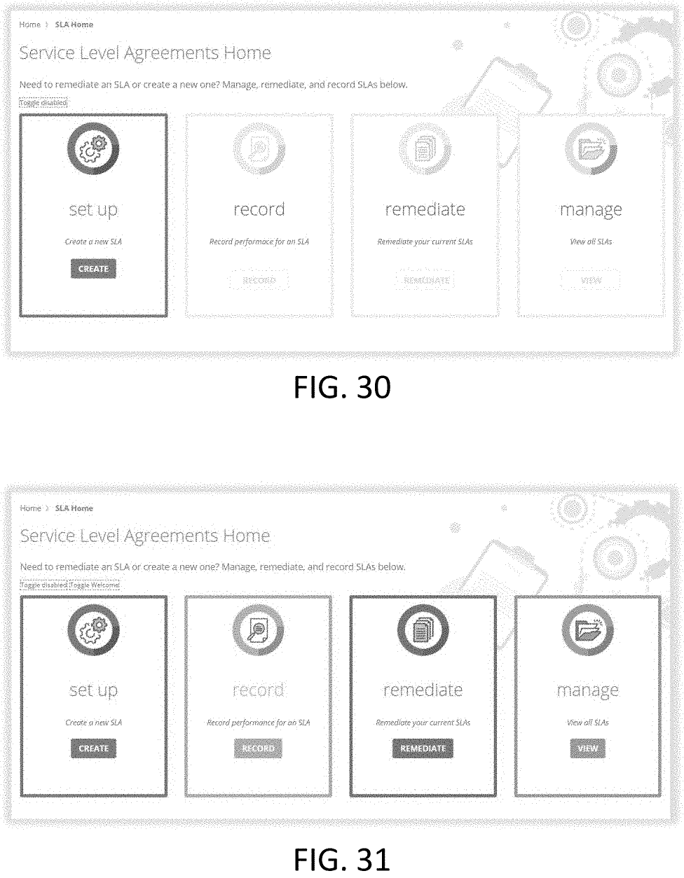

In some embodiments, system 100 includes an SLA homepage, e.g., an SLA homepage that is or comprises the main landing spot for the SLA management module. This homepage allows a user (e.g., client user) to access one or more of a set up, record, remediate, and/or manage section of the module. Upon first landing on the SLA homepage, a client may be presented with only one active tile, e.g., the set up tile. FIG. 30 is an example SLA landing page (no SLAs) workspace, in accordance with an embodiment of the invention. Additional options (tiles) on the SLA home page may become active (e.g., selectable by a user, e.g., by clicking) when one or more SLAs are established (e.g., appropriate database entries have been created). In some embodiments, activation of additional tiles occurs automatically (e.g., activation by a processor), e.g., when a processor of the system receives one or more trigger signals. Example triggers for the record tile include a signal that at least one SLA is loaded into the system. Example triggers for the remediate tile include a signal that at least one SLA has been marked for remediation (e.g., by a user). Example triggers for the manage tile include a signal that at least one SLA is loaded into the system. FIG. 31 is an example SLA landing page (SLAs entered) workspace, in accordance with an embodiment of the invention.

Set Up Tile

In some embodiments, an example system 100 includes a set up module where an SLA maybe created initially.

Base Information

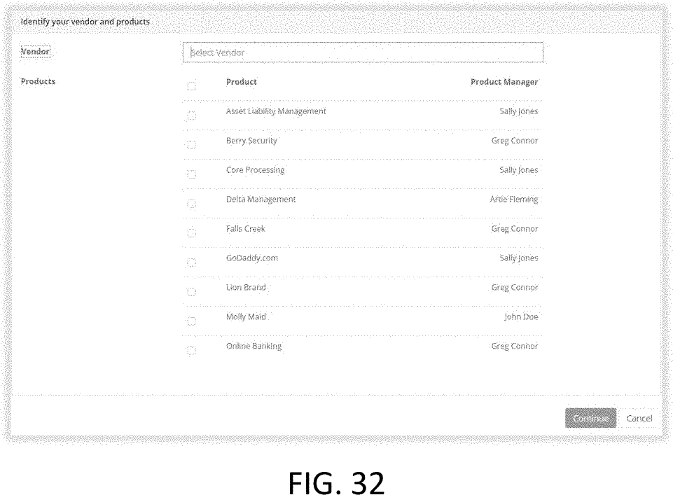

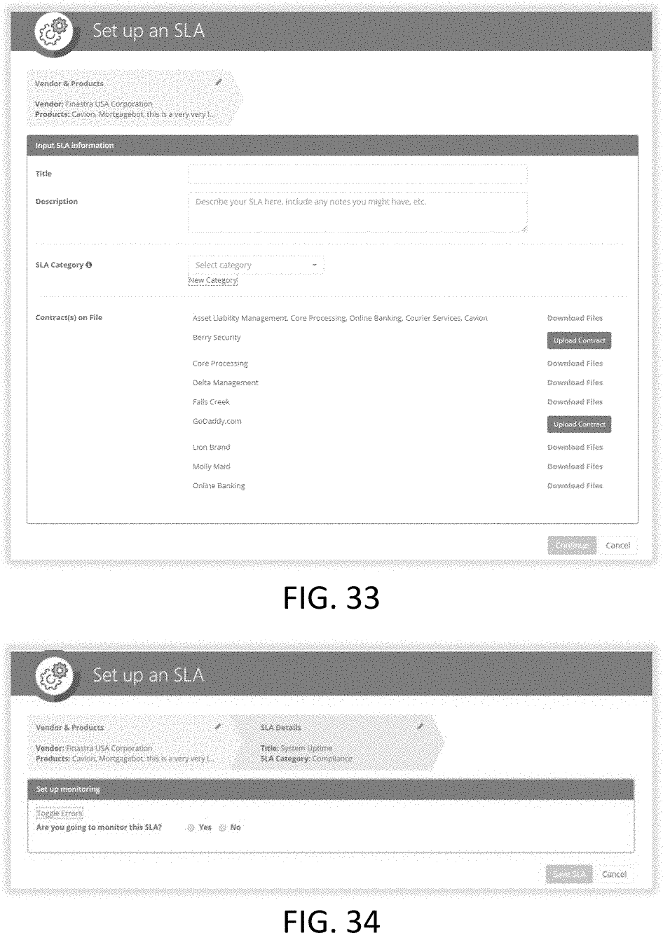

In some embodiments, one or more vendors and/or products may be selected first from already existing entities that have been previously entered into, e.g., system 100. FIG. 32 is an example vendor and product selection workspace, in accordance with an embodiment of the invention. In some embodiments, the next sections of the SLA may assigned by a user, e.g., a client user. A user may provide, via a GUI, SLA title and description, along with a client set of SLA categories. Then, existing contracts may be downloaded and/or viewed, or may be uploaded during this step. FIG. 33 is an example additional SLA information input workspace, in accordance with an embodiment of the invention. In some embodiments, the next step may be determining if the SLA will be monitored. If not, then an SLA may be saved, and the user (e.g., client user) may either return to the SLA homepage, or add another SLA. FIG. 34 is an example SLA details workspace, in accordance with an embodiment of the invention.

Monitoring

In some embodiments, if monitoring is required for one or more SLAs, a subsequent (or parallel) workspace or section of a workspace may be presented to record require information. In some embodiments, an SLA team may be assigned, along with escalation contacts. Monitoring frequency, which may be set from a daily to an annual setting, may then be established along with the first monitoring report reminder date. Any supporting documentation may also be added (e.g., input via a GUI or upload) at this time, e.g., either directly from a vendor (e.g., a vendor system) or, e.g., another provider system that is used to manage performance on behalf of the vendor.

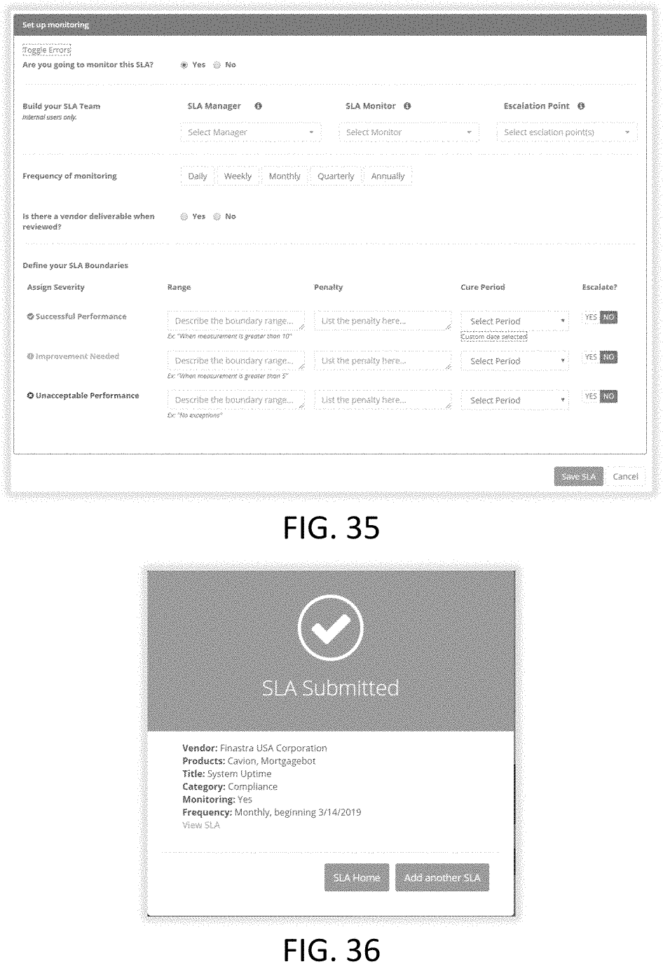

A user (e.g., a client user) may establish SLA boundaries for a monitored performance. In some embodiments, an SLA module may have a number (e.g., 1, 2, 3, 4, 5, 10, or more) of severity settings, e.g., three settings: 1—successful performance; 2—improvement needed; and 3—unacceptable performance. A user, e.g., a client user, may then set, via a workspace GUI receiving user input, a range, penalty, cure period and/or escalation status for each boundary. The range may be the measuring criteria for that SLA. In some embodiments, a (pre-set) penalty may establish the financial or contractual penalty if a measurement falls within that severity. In some embodiments, a cure period may be the timeframe specified for the performance to improve. In some embodiments, an escalate setting may define who should be notified on the SLA team when an SLA falls into a less than successful performance severity. This notification may be done by an email sent out daily by the system/provider application. In some embodiments, a notification email is generated automatically, e.g., by the processor, and sent automatically, by the processor, to one or more pre-programmed recipient addresses, e.g., addresses stored in one or more databases accessible by one or more processors. FIG. 35 is an example SLA monitoring setup workspace, in accordance with an embodiment of the invention. Once completed, a user, e.g., a client user, may be presented with an SLA submitted modal, showing a basic recap of the SLA information just entered. A user may then have the option to return to the SLA homepage, or to add another SLA. FIG. 36 is an example SLA submitted modal workspace, in accordance with an embodiment of the invention.

Record Tile

In some embodiments, a user, e.g., a client user, may access a record module when recording the performance for an SLA.

Landing Page

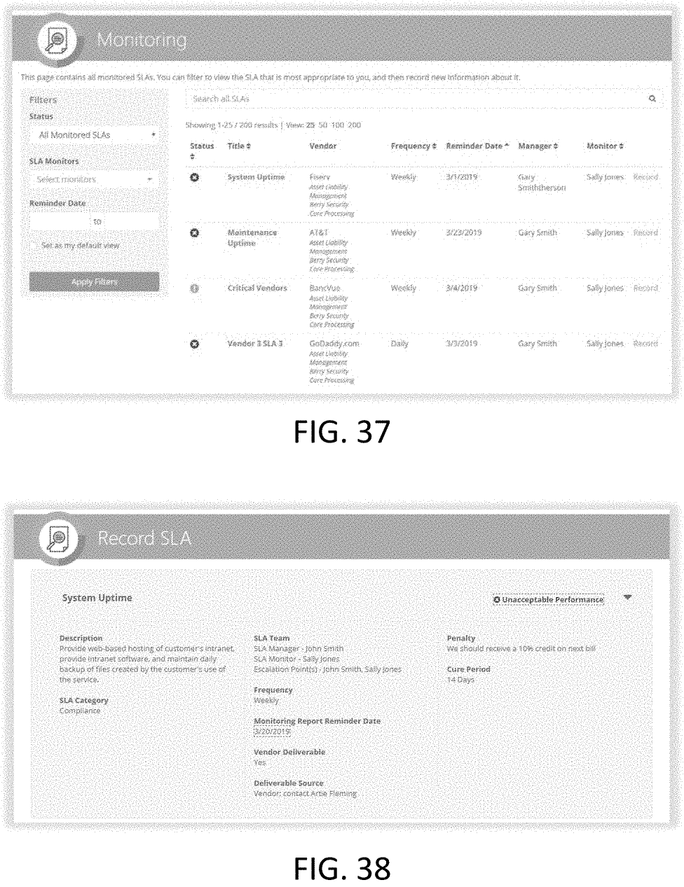

In some embodiments, an SLA monitoring landing page may provide a listing of a plurality (e.g., all) of a user's monitored SLAs. The list may be filtered by severity status, specific monitors, and/or selected reminder dates. In addition to the filters provided, a user may also sort one or more (e.g., all) columns presented in the listing. In some embodiments, information presented on the monitoring landing page may include (e.g., consist of) status, title, vendor, frequency, reminder date, manager, and/or monitor information. A user may also have the option to view more specific SLA information by selecting (e.g., clicking) a title. This action may cause the processor to present the user with a view SLA page, e.g., as described herein. FIG. 37 is an example SLA monitoring landing page workspace, in accordance with an embodiment of the invention.

In some embodiments, a reminder date may be used to determine if an SLA review is considered past due. When the current date is one day greater than the current review window's start date AND there is no review present in the system with an as-of date that falls within the current review window, the SLA may be considered past due and may be represented as such by the system, e.g., using a color indicator on the SLA monitoring landing page workspace. The following example illustrates an example implementation:

On Oct. 30, 2018, an SLA was created with a monitoring frequency of monthly and the first monitoring reminder date of Nov. 1, 2018. A first review window is Nov. 1, 2018-Nov. 30, 2018. A second review window is Dec. 1, 2018-Dec. 31, 2018. A third review window is Jan. 1, 2019-Jan. 31, 2019.

Scenario 1: Today is Dec. 4, 2018 and a review has never been completed. The SLA review would be considered past due and the SLA appears in the list with a reminder date of Nov. 1, 2018. In some embodiments, a visual cue may be provided by the system, e.g., a date may be displayed in red font.

Scenario 2: A review is performed today with an as-of date of Nov. 15, 2018. The SLA review would still be considered past due and the SLA appears in the list with a reminder date of Dec. 1, 2018. In some embodiments, a visual cue may be provided by the system, e.g., a date may be displayed in red font.

Scenario 3: A review is performed today with an as of date of Dec. 4, 2018. The SLA Review would NOT be past due and the SLA appears in the list with a reminder date of Jan. 1, 2019. In some embodiments, a visual cue may be provided by the system, e.g., a date may be displayed in standard font.

In some embodiments, there may only be one line entry displayed per SLA that is currently being monitored. In some embodiments, alternatively or in addition to the system presenting a visual cue, e.g., for an overdue review (e.g., representing a reminder date in a red font for an overdue performance review), an email may be automatically generated and sent to one or more recipients, by the system, e.g., showing actions for today showing an SLA performance review has come due.

Record SLA Page

In some embodiments, a purpose (e.g., the main purpose) of this record SLA module may be to record SLA performance. In some embodiments, this may be accomplished by selecting a “record” link associated with the SLA. This action may take a user to the record SLA page. In some embodiments, a record SLA page workspace may include two sections: First, an information well, and second, a record vendor SLA performance section.

In some embodiments, the information well may be or include a collapsible summary view of the SLA. Some or all information concerning an SLA may be presented. In some embodiments, some or all information concerning an SLA may be presented except for any related contracts or associated documents. This information may include: title, description, category, team, frequency, monitoring report reminder date, vendor deliverable, deliverable source, penalty, cure period, and/or current severity level. FIG. 38 is an example record SLA information well workspace, in accordance with an embodiment of the invention.

In some embodiments, a second section may allow a user, e.g., a client user, to record performance data for an SLA. In some embodiments, an as-of date may be populated for today or any past date when a performance was recorded. There may also be provided an option to upload any relevant documentation. In some embodiments, a document may be uploaded directly from a user's computer and/or from a document storage inside of the system application (e.g., a database, e.g., a cloud-based database).

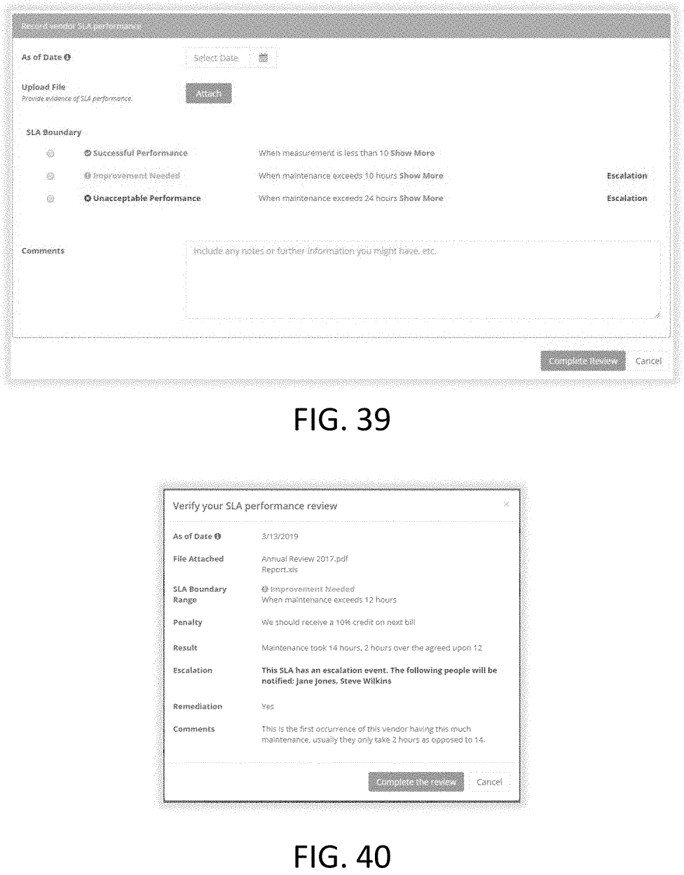

In some embodiments, a user may then select one or more boundaries associated with a performance review. Comments may also be added to help define why this severity level was chosen. A user may then put the SLA into remediation as well. FIG. 39 is an example record vendor SLA performance workspace, in accordance with an embodiment of the invention. After completing a performance review, a user may be presented with a verification modal widget allowing the user to review the information entered. FIG. 40 is an example SLA performance review verification confirmation modal window, in accordance with an embodiment of the invention.

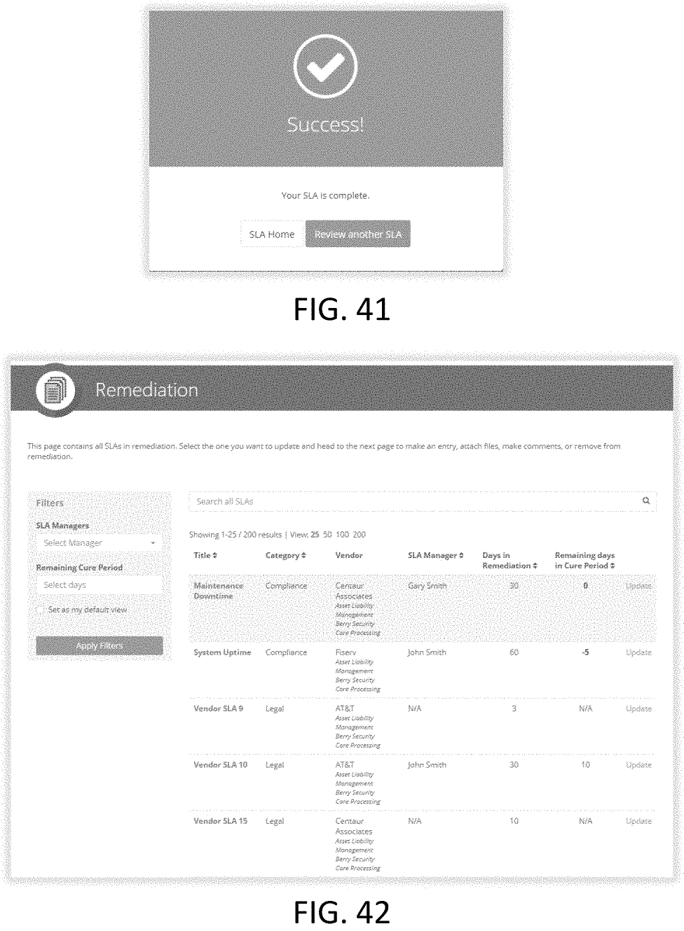

In some embodiments, after completing a process, e.g., an SLA review process, a user then has the option to return to the SLA homepage, or to review another SLA. FIG. 41 is an example SLA performance review confirmation modal workspace, in accordance with an embodiment of the invention.

Remediate Tile

In some embodiments, a user, e.g., a client user, may access a remediation module when managing the remediation for one or more SLAs.

Landing Page

In some embodiments, an SLA remediation landing page may provide a listing of a plurality (e.g., all) of a user's SLAs in remediation. The list may be filtered by specific managers and/or remaining cure periods. In addition to the filters provided, a user may also sort one or more (e.g., all) columns presented in the listing.

In some embodiments, information presented on the remediation landing page may include (e.g., consist of) title, category, vendor, SLA manager, days in remediation, and/or remaining days in cure period. A user may also have the option to view more specific SLA information by selecting one or more titles. This action may cause the processor to present a user with the View SLA page, e.g., as described herein. FIG. 42 is an example SLA remediation landing page workspace, in accordance with an embodiment of the invention.

Update Remediation Page

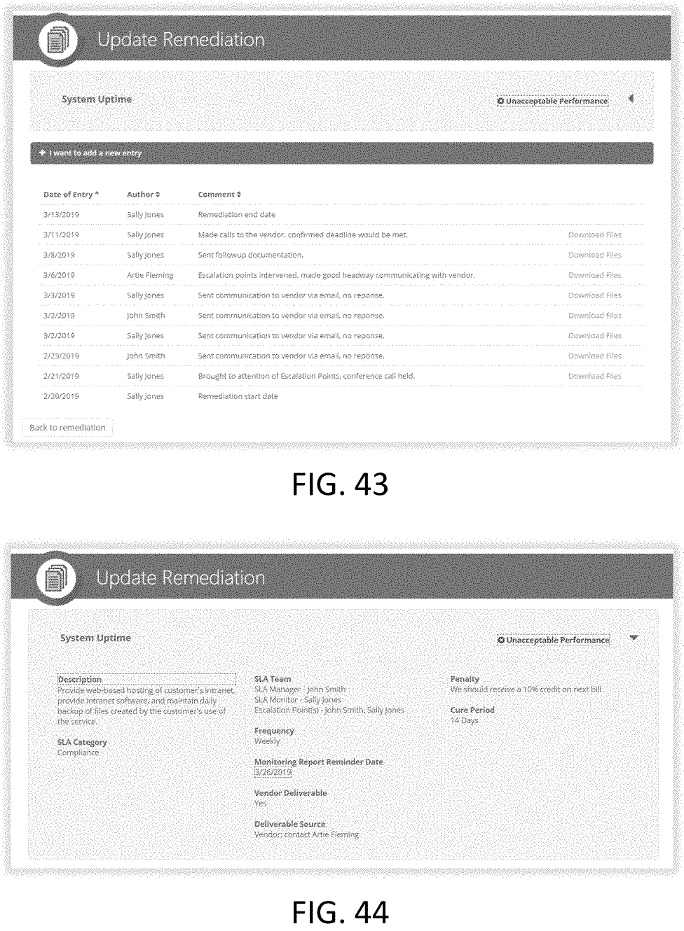

In some embodiments, a purpose (e.g., the main purpose) of this update remediation module is to update the remediation status of an SLA. In some embodiments, this may be accomplished by selecting the “update” link associated with the SLA. This action may take a user to an update remediation page. In some embodiments, this workspace may include (e.g., consist of) three sections: information well, workspace for adding a new journal entry, and/or remediation journal entries log. FIG. 43 is an example SLA update remediation page workspace, in accordance with an embodiment of the invention.

In some embodiments, an information well may be or comprise a collapsible summary view of an SLA. Some or all information concerning an SLA may be presented. In some embodiments, some or all information concerning an SLA may be presented except for any related contracts or associated documents. This information may include: title, description, category, team, frequency, monitoring report reminder date, vendor deliverable, deliverable source, penalty, and/or cure period. FIG. 44 is an example update remediation information well workspace, in accordance with an embodiment of the invention.

In some embodiments, a second section may allow a user, e.g., a client user, to record a journal entry for an SLA. In some embodiments, an as of date may be populated for today or any past date when a journal entry is needed. There may also be provided an option/data field for adding any comments needed to document this SLA while in remediation. There may also be provided an option to upload any relevant documentation. In some embodiments, a document may be uploaded directly from a user's computer and/or from a document storage inside of the system application (e.g., a database, e.g., a cloud-based database).

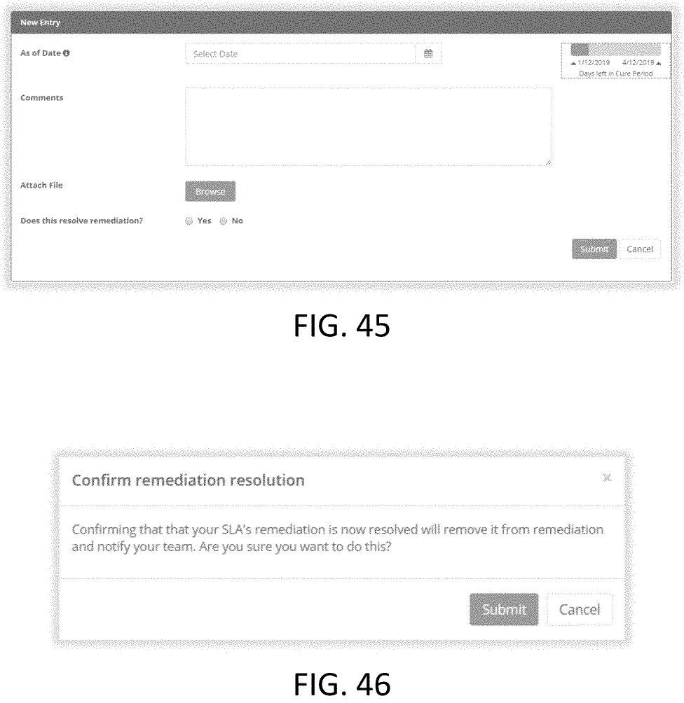

In some embodiments, a user may then select whether the SLA should remain in remediation based on the information entered in this journal entry. FIG. 45 is an example SLA remediation journal entry workspace, in accordance with an embodiment of the invention. If a user marks an SLA to be removed from remediation, they are warned with a confirmation modal, which may be automatically generated by a processor. FIG. 46 is an example confirm remediation resolution modal workspace, in accordance with an embodiment of the invention.

Manage Tile

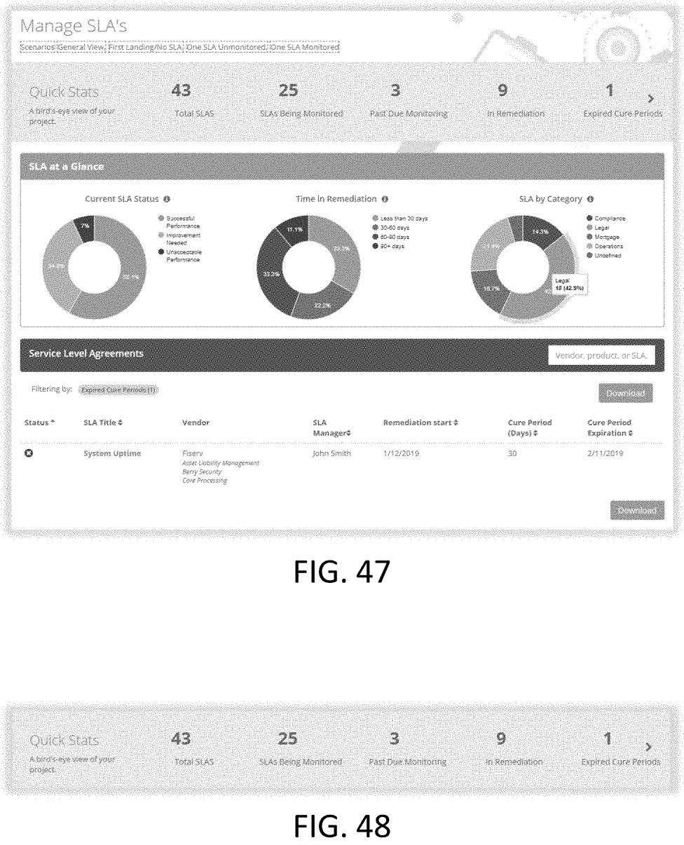

In some embodiments, a user, e.g., a client user, may access a manage module. This module may provide an overview of all active SLAs in the system/provider application. In some embodiments, a manage module may include or may be composed of three sections, two of which may be interactive. The sections may include a quick stats area, an SLA at a glance area, and an SLA details area, which may display results from the first two sections. FIG. 47 is an example manage SLA's landing page, in accordance with an embodiment of the invention.

Quick Stats

In some embodiments, this section or window may allow a user to quickly view, e.g., a total number of SLAs for each of the following: total SLAs, SLAs being monitored, past due monitoring, in remediation, expired cure periods, and/or archived SLAs. In some embodiments, a user may then select any of the displayed summary counts and have those SLAs filtered and displayed, e.g., in the SLA details section at the bottom of this module. This section may provide an accurate and quick overview of the state of SLAs within the system/provider application. FIG. 48 is an example SLA quick stats workspace, in accordance with an embodiment of the invention.

SLA at a Glance

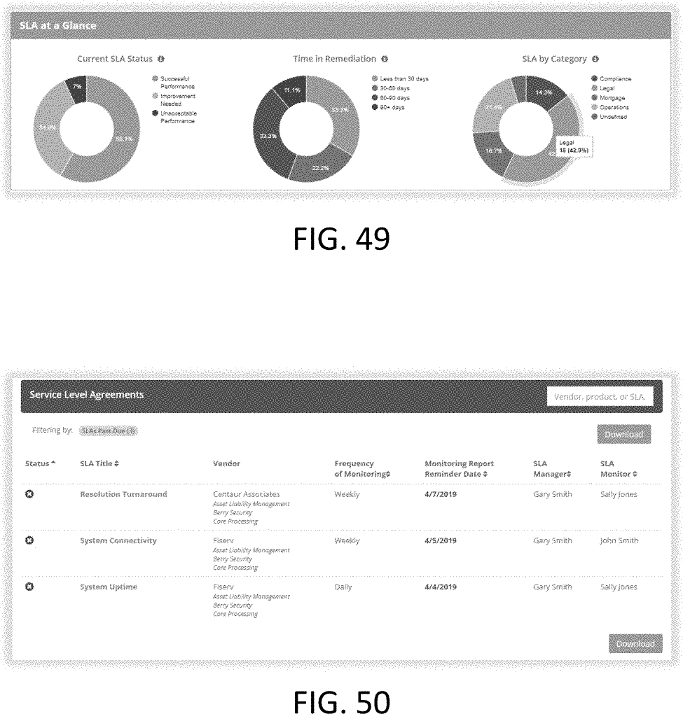

In some embodiments, an SLA at a glance feature may act like the quick stats feature in that filtered lists of the SLAs may be provided once a section of the graphs or legends is selected. In some embodiments, three featured graphs include: current SLA status, time in remediation, and/or SLA by category. These graphs may provide an insight to the overall status of SLAs for a user, e.g., c client user. In some embodiments, by hovering with a mouse cursor over each item, a user may be presented with information (e.g., through a temporary or pop-up window) regarding a number of SLAs in that status. Clicking on each of the data points may return (e.g., through a temporary or pop-up window or workspace) the selected dataset information in the SLA details section. FIG. 49 is an example SLA at a glance workspace, in accordance with an embodiment of the invention.

SLA Details

In some embodiments, an SLA detail section may provide a listing of a filtered selection chosen by a user, e.g., in the quick stats or SLA at a glance sections. A user may also sort some or all columns presented in the listing.

In some embodiments, the information presented on the SLA details page may vary depending on filter selection. A user may have the option to view more specific SLA information by selecting a title. This selection may present a client with a view SLA page, e.g., as described herein. FIG. 50 is an example SLA details list workspace, in accordance with an embodiment of the invention.

View SLA

In some embodiments, a user, e.g., a client user, may access a view SLA module. A view SLA feature may provide both details and historical views of an SLA and its performance data. In some embodiments, this page may be accessed from different locations within the system/provider application.

Details

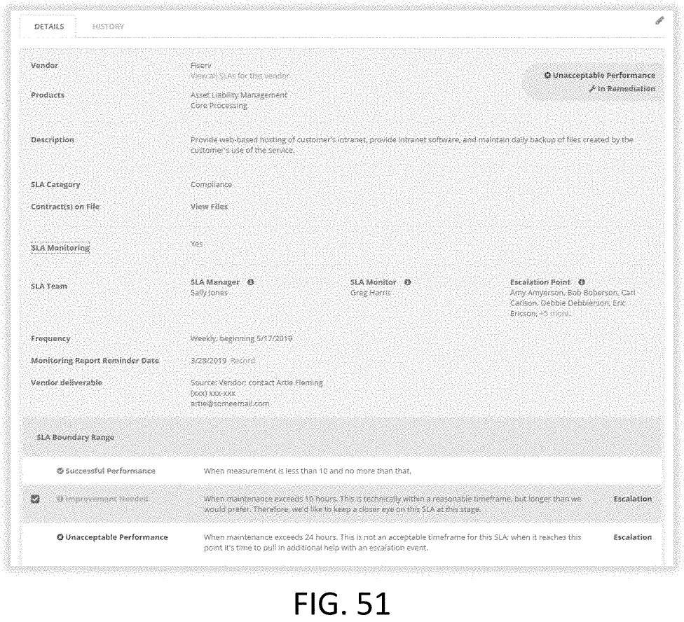

In some embodiments, an SLA module may include a details tab. In some embodiments, some or all information concerning an SLA is presented to a user, including any related contracts or associated documents. This information may include: vendor(s), product(s), description, category, contract(s) on file, download links, SLA monitoring status, team, SLA manager, SLA monitor, escalation point, frequency, monitoring report, reminder date, record link, vendor deliverable and source, and/or SLA boundary range. FIG. 51 is an example view SLA details workspace, in accordance with an embodiment of the invention.

History

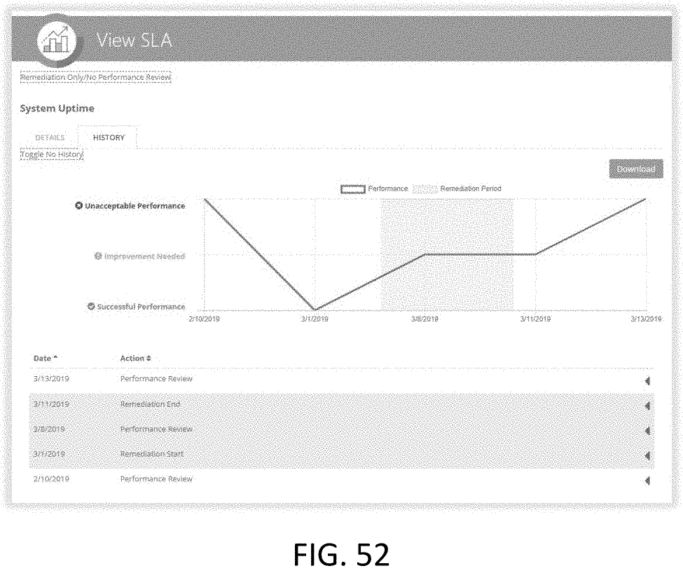

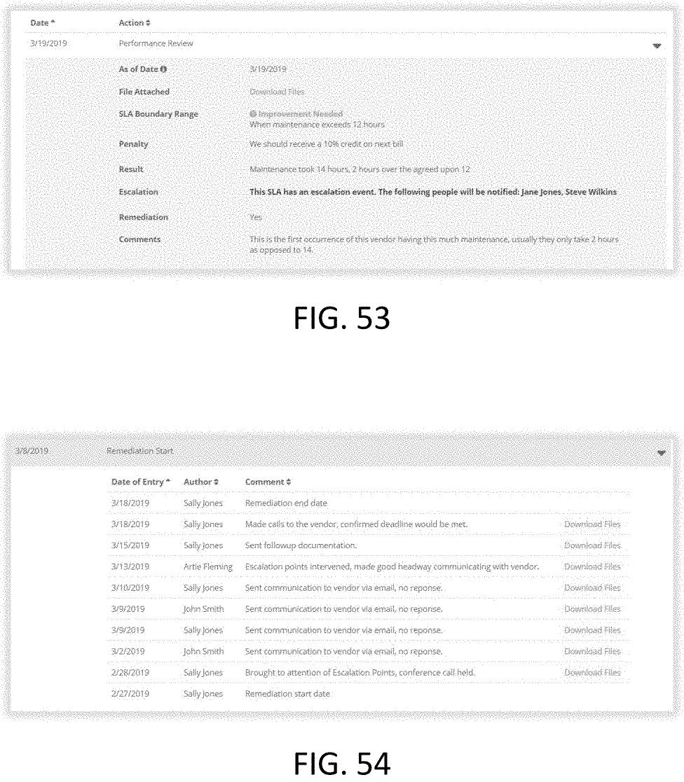

In some embodiments, an SLA module may include a history tab. In some embodiments, the history tab may provide a GUI including a graphical trend line along with a log section that shows historical events for a specific SLA. These events may include performance reviews and/or remediation start and stop events. These events may be displayed in a collapsible view interface, and, when expanded, may show additional information. FIG. 52 is an example view SLA history workspace, in accordance with an embodiment of the invention. In some embodiments, e.g., for performance reviews, example information may include: as-of date, file(s) attached (e.g., displayed as download links); SLA boundary range (e.g., as assigned during a performance review), penalty, result, escalation, remediation, and/or comments. FIG. 53 is an example SLA performance review detail workspace, in accordance with an embodiment of the invention.

In some embodiments, a remediation start and end event interface may show journal entries that were created while the SLA was in a remediation status. In some embodiments, an associated download files link may be provided. In some embodiments, information shown for these events include: date of entry, author, and/or comment. FIG. 54 is an example SLA remediation event detail workspace, in accordance with an embodiment of the invention.

Edit

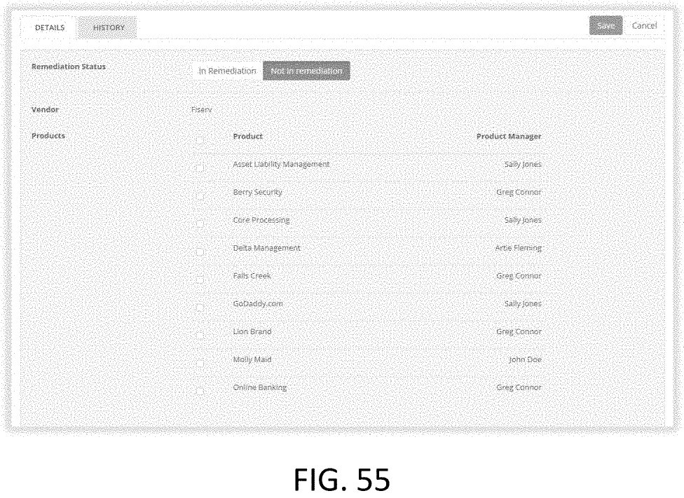

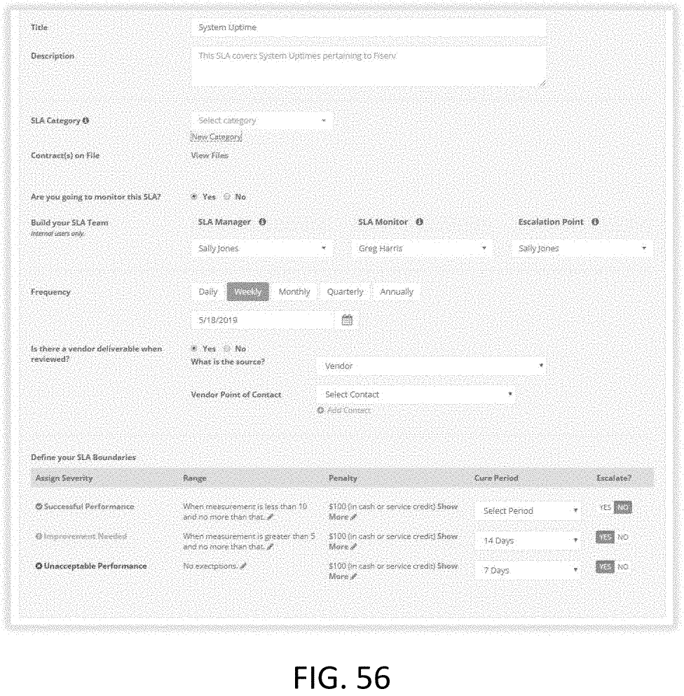

In some embodiments, an edit functionality on the view SLA page may allow for maintenance of all aspects for an SLA. In some embodiments, an edit functionality on the View SLA page may allow for maintenance of all aspects for an SLA, except uploading new contracts or documents. When an SLA is in an editing state, a user may determine if the SLA is considered in or out of remediation. A user may also select or deselect products to be associated with the SLA. FIG. 55 is an example edit SLA details workspace, in accordance with an embodiment of the invention. A user may be provided an option to edit one or more of the following SLA items: title, description, category, view contracts (e.g., no editing or uploading), monitoring status, SLA team (e.g., manager, monitor, escalation point), frequency (e.g., daily, weekly, monthly, quarterly, annually), frequency reminder date, vendor deliverable, vendor deliverable source, and/or SLA boundaries. FIG. 56 is an example edit SLA details workspace, in accordance with an embodiment of the invention.

View Vendor SLAs

In some embodiments, a user, e.g., a client user, may access a view vendor SLA module. The view vendor SLA feature may provide both active and archived views of some or all the SLAs for a particular vendor. In some embodiments, this module may be accessed either from the view SLA page or from the contract details view within the system/provider application.

Active

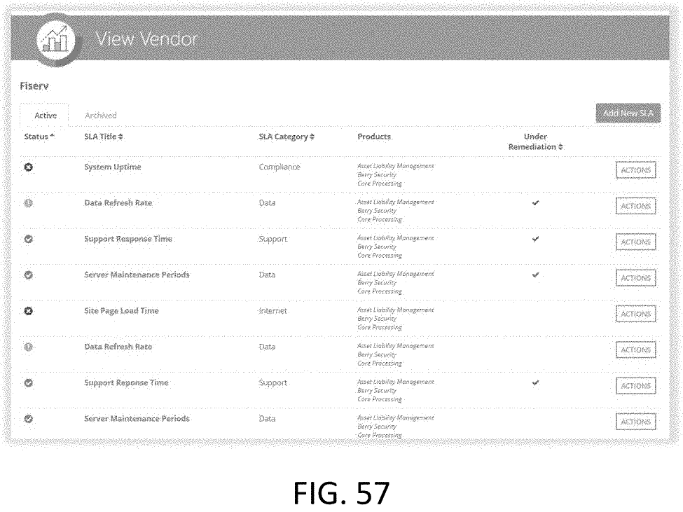

In some embodiments, a user may access an active tab showing all active SLAs for a particular vendor. The user may also sort some or all columns presented in the listing. In some embodiments, information presented on the view vendor active page may include status, title, category, products, under remediation flag and/or one or more actions buttons. A user may be provided with an option to view more specific SLA information, e.g., by selecting the title. In some embodiments, selecting a title may cause the user to be presented with the view SLA page as described herein. A user may also be provided, e.g., via a widget, with an add new SLA button, the selection of which may cause a user to be presented with the first section of the set up SLA section, e.g., as described herein. FIG. 57 is an example view vendor SLAs—active workspace, in accordance with an embodiment of the invention.

In some embodiments, selecting an actions button may cause a user to be provided with three options for the selected SLA. These options may include view, edit, and/or archive.

In some embodiments, selecting the view option may cause a user to be presented with a view SLA page, e.g., as previously described. In some embodiments, selecting the edit option may cause a user to be presented with a view SLA page already opened in edit mode.

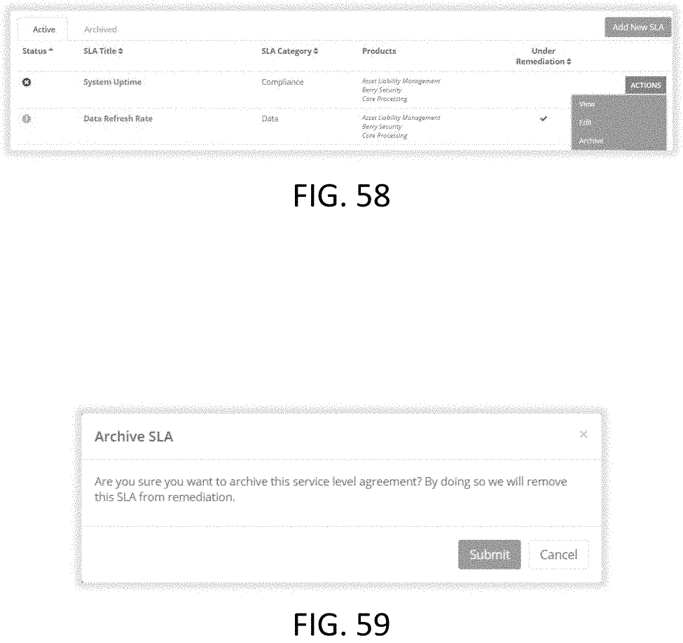

FIG. 58 is an example view vendor SLA active tab actions workspace in accordance with an embodiment of the invention. In some embodiments, selecting the archive option may allow the client to archive an SLA. Once selected, a user may be presented with a confirmation modal, e.g., in combination with moving an SLA to the archived listing. In some embodiments, an SLA in remediation may be removed from that status as well when archived. FIG. 59 is an example archive confirmation modal workspace, in accordance with an embodiment of the invention.

Archived

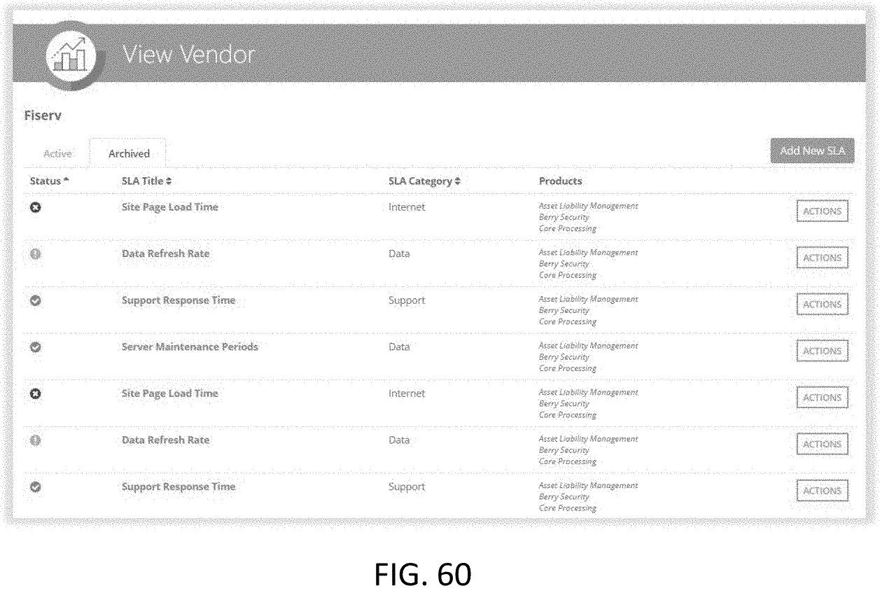

In some embodiments, a user may access an archive tab showing all archived SLAs for a vendor. A user may also sort some or all columns presented in the listing. Information presented on the view vendor archived page may include status, title, category, products, and/or one or more action buttons. A user may be presented with the option to view more specific SLA information, e.g., by selecting the title. This selection may cause a user to be presented with a view SLA page, e.g., a described herein. In some embodiments, a user may be denied the option to edit any entry (e.g., document or other information in a database) while in the archive view of the SLA. In some embodiments, a user may be presented with an add new SLA button, the selection of which may cause a user to be presented with the first section of a set up SLA section, e.g., as described herein. FIG. 60 is an example view vendor SLAs—archived workspace, in accordance with an embodiment of the invention.

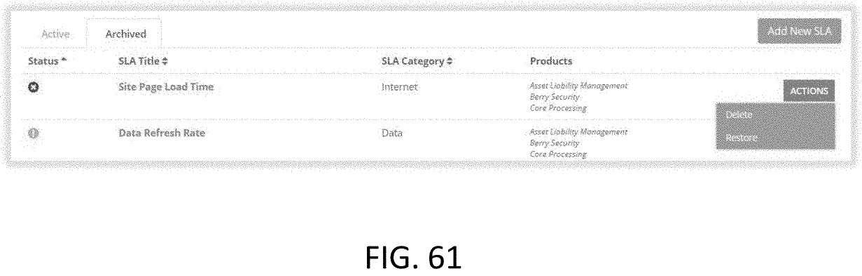

In some embodiments, selecting an actions button may cause a user to be provided with, e.g., two options for the selected SLA. The options may include delete and/or restore. FIG. 61 is an example view vendor SLA archived tab actions workspace, in accordance with an embodiment of the invention.

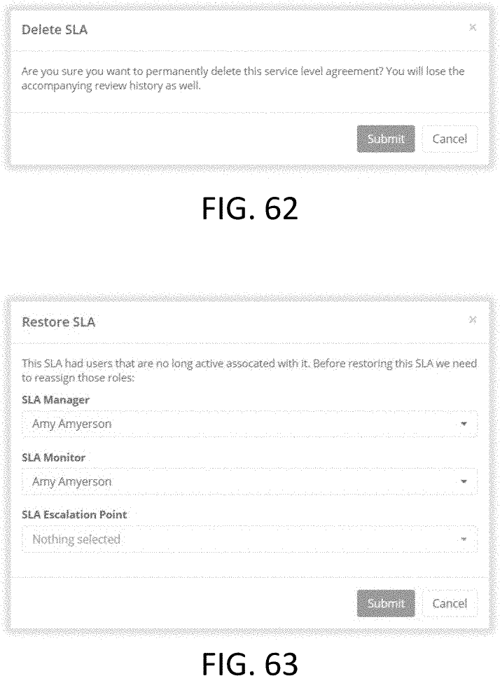

In some embodiments, selecting the delete option may cause permanent deletion of an SLA. In some embodiments, a user may be provided (automatically, by the processor) with a confirmation modal widget before deletion of an SLA is executed. If confirmed, the SLA may be removed from the archived listing and (e.g., permanently) deleted from the system/provider application. FIG. 62 is an example delete confirmation modal workspace, in accordance with an embodiment of the invention.

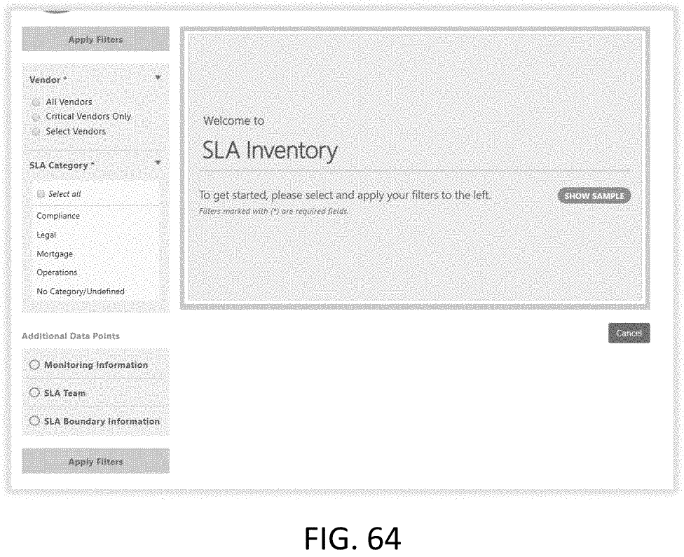

In some embodiments, selecting the restore option may cause a user to be presented with a restore SLA modal widget, where an SLA team may be selected. In some embodiments, information relating to a team previously associated with an SLA may be prefilled into the form. In the case where a team member is no longer active, an alternate selection may be made by the user. Once this selection is submitted, an archived SLA is returned to an active status (e.g., automatically, by a processor). An SLA may be removed from the archived listing and returned to the active listing. In some embodiments, if the SLA was in remediation when it was archived, its status will not be returned automatically to a remediation status. FIG. 63 is an example restore SLA modal workspace, in accordance with an embodiment of the invention. In some embodiments, an SLA may also be placed into an archived status whenever an associated product is deactivated, or an associated contract is cancelled.

Reporting

SLA Inventory

In some embodiments, a user may access an SLA inventory report module workspace. An SLA inventory report workspace may provide to a user a list of some or all vendors that have an active SLA setup within the system/provider application. FIG. 64 is an example reporting—SLA inventory landing page workspace, in accordance with an embodiment of the invention. In some embodiments, data that may be included in a report may include vendor, product, criticality, SLA category, SLA title, and/or SLA description.

SLA Performance

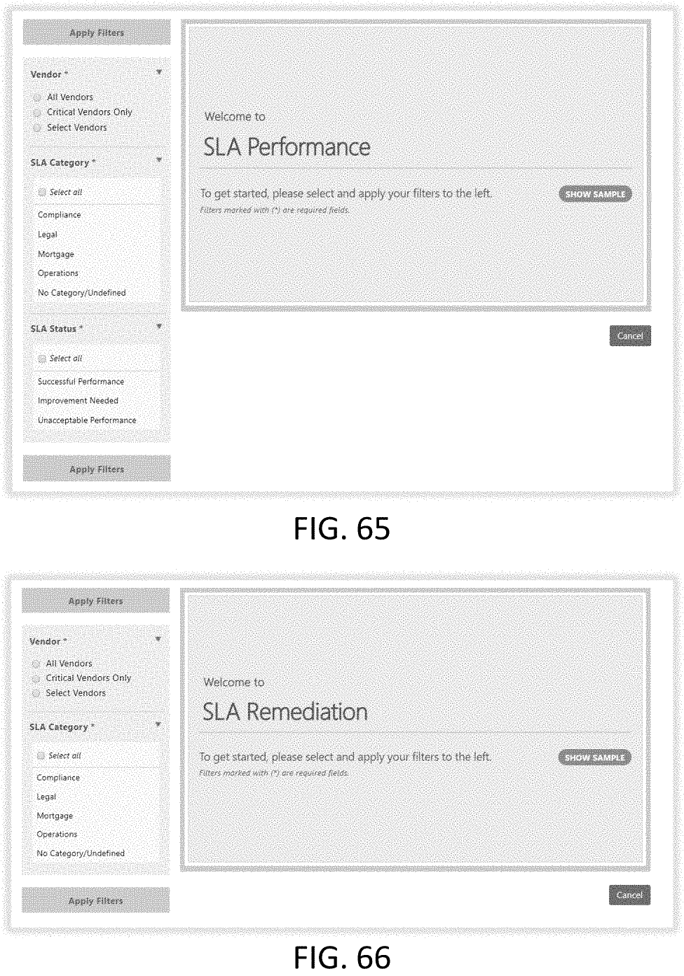

In some embodiments, a user may access an SLA performance report module. An SLA performance report module may display to a user the current statuses of one or more SLAs, based on boundary levels set by a user, e.g., based on a user or user institution requirements. FIG. 65 is an example reporting—SLA performance landing page workspace, in accordance with an embodiment of the invention. In some embodiments, data that may be included in a report may include vendor, product, criticality, SLA category, SLA title, SLA description, a current SLA status section (e.g., as of date, performance level, comments), a monitoring section (e.g., monitoring, monitoring frequency, next monitoring report reminder date), and/or an SLA team section (manager, monitor, escalation).

SLA Remediation

In some embodiments, a user may access an SLA remediation module. An SLA remediation module may display to a user all SLAs currently in remediation. FIG. 66 is an example reporting—SLA remediation landing page workspace, in accordance with an embodiment of the invention. In some embodiments, data that may be included in a report may include vendor, product, criticality, SLA category, SLA title (e.g., SLA manager, placed in remediation by), SLA description, and/or a remediation data section (recent remediation entry date, author of recent remediation entry, recent entry, remediation start date, cure period, days remaining in cure period, and/or penalty).

SLA Performance Trends

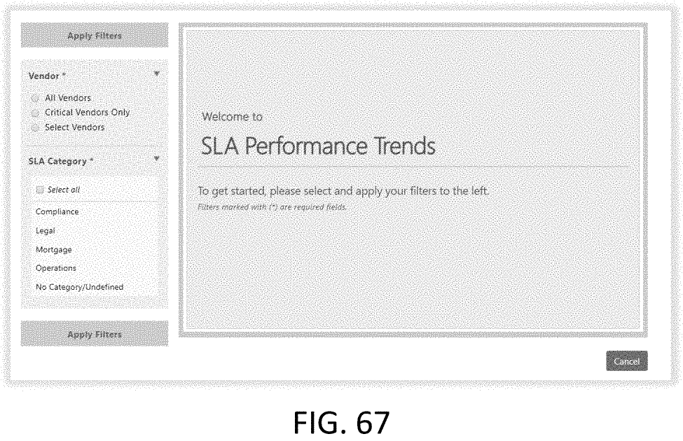

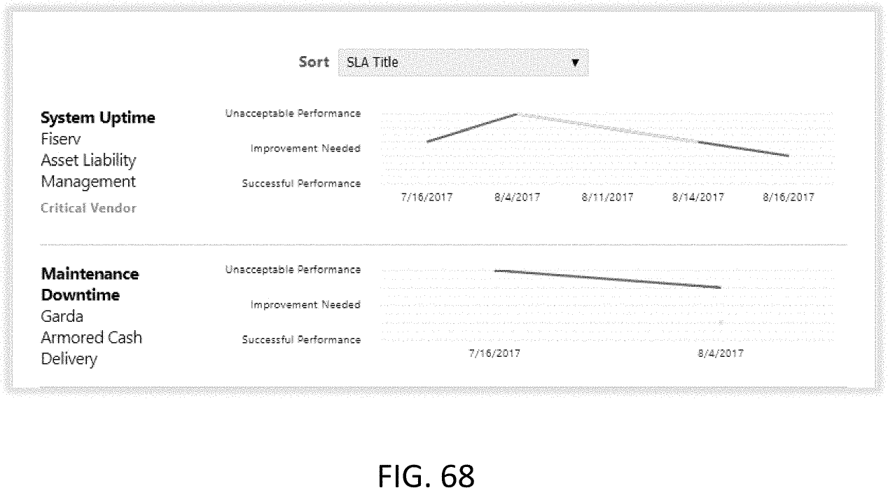

In some embodiments, a user may access an SLA performance trends module. An SLA performance trends module may provide to a user a general overview of how one or more SLAs are performing. FIG. 67 is an example reporting—SLA performance trends landing page workspace, in accordance with an embodiment of the invention. In some embodiments, relevant data may be displayed in graphical format. FIG. 68 is an example SLA performance trends graphical report workspace, in accordance with an embodiment of the invention.

Email Notifications

In some embodiments, an SLA module may be configured to generate (e.g., automatically, e.g., without user interaction), by a processor, one or more notifications (e.g., generate and send one or more emails, cause to display a widget) when certain activities occur to alert, e.g., managers and the SLA team. Example emails and their (automatic) triggers are shown in Table 5:

TABLE 5

| Email Template | Description | Trigger |
|---|---|---|
| Ownership Reassigned | Notifies recipient that they have been | Email is sent immediately |
| | assigned ownership of an SLA. | by the system when |
| | | ownership is reassigned to |
| | | another user, e.g., by a |
| | | system administrator. |
| Today's SLA Activity | Notifies the recipient of the following | Email is automatically |
| | events: | generated and sent to the |
| | SLA is placed into remediation | recipient each day, if one |
| | An SLA in remediation exceeds | or more of the events |
| | the cure period | occur on that day. |
| | An SLA is removed from | |
| | remediation | |
| | There is a performance review | |
| | completed which required | |
| | escalation | |
| | There is a performance review that | |
| | has become due | |

User Roles

In some embodiments, two general user roles may be assigned to users of the system/provider application, e.g., an administrator role and/or a general user role. In some embodiments, an administrator user may be provided, by the system 100, permission to manage other users such as adding, editing or deleting users.

In some embodiments, a general user may be provided, by the system 100, permission access one or more components and/or modules of the system. A general user may be provided with the ability to add themselves as product managers and/or collaborators.

In some embodiments, within an SLA module, users may be defined by their role in managing and overseeing SLAs. These roles may be established when assigning an SLA team as described herein. In some embodiments, roles include SLA manager (a person with the overall responsibility for the SLA), SLA monitor (a person with day to day responsibilities for the SLA), and/or escalation contact (there may be multiple escalation contacts for an SLA). In some embodiments, there is no restriction as to which role user (administrator or general user) may create, edit, archive or delete SLAs.

Exemplary Network Environment and Computing Device

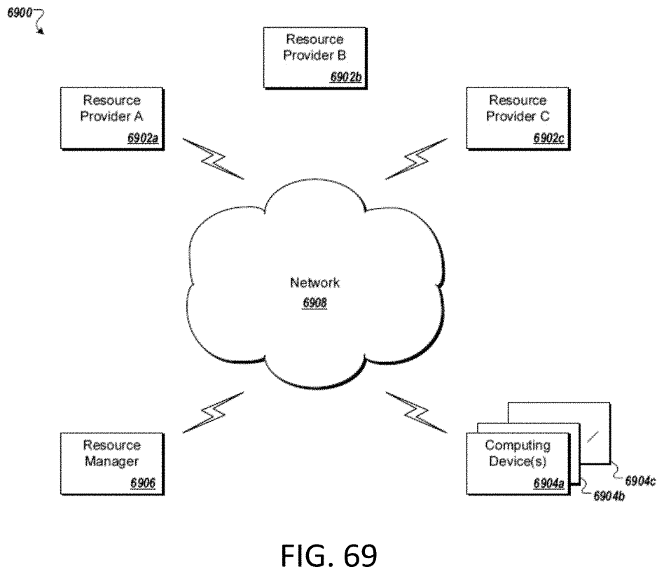

FIG. 69 shows an illustrative network environment 6900 for use in the methods and systems described herein. In brief overview, referring now to FIG. 69, a block diagram of an exemplary cloud computing environment 6900 is shown and described. The cloud computing environment 6900 may include one or more resource providers 6902a, 6902b, 6902c (collectively, 6902). Each resource provider 6902 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 6902 may be connected to any other resource provider 6902 in the cloud computing environment 6900. In some implementations, the resource providers 6902 may be connected over a computer network 6908. Each resource provider 6902 may be connected to one or more computing device 6904a, 6904b, 6904c (collectively, 6904), over the computer network 6908.

The cloud computing environment 6900 may include a resource manager 6906. The resource manager 6906 may be connected to the resource providers 6902 and the computing devices 6904 over the computer network 6908. In some implementations, the resource manager 6906 may facilitate the provision of computing resources by one or more resource providers 6902 to one or more computing devices 6904. The resource manager 6906 may receive a request for a computing resource from a particular computing device 6904. The resource manager 6906 may identify one or more resource providers 6902 capable of providing the computing resource requested by the computing device 6904. The resource manager 6906 may select a resource provider 6902 to provide the computing resource. The resource manager 6906 may facilitate a connection between the resource provider 6902 and a particular computing device 6904. In some implementations, the resource manager 6906 may establish a connection between a particular resource provider 6902 and a particular computing device 6904. In some implementations, the resource manager 6906 may redirect a particular computing device 6904 to a particular resource provider 6902 with the requested computing resource.

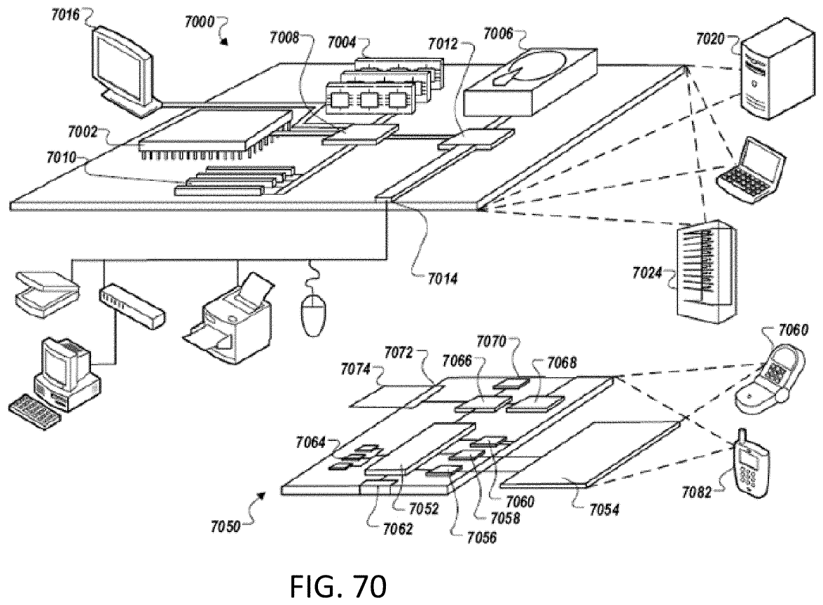

FIG. 70 shows an example of a computing device 7000 and a mobile computing device 7050 that can be used in the methods and systems described in this disclosure. The computing device 7000 is intended to represent various forms of digital computers, such as laptops, desktops, workstations, personal digital assistants, servers, blade servers, mainframes, and other appropriate computers. The mobile computing device 7050 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 7000 includes a processor 7002, a memory 7004, a storage device 7006, a high-speed interface 7008 connecting to the memory 7004 and multiple high-speed expansion ports 7010, and a low-speed interface 7012 connecting to a low-speed expansion port 7014 and the storage device 7006. Each of the processor 7002, the memory 7004, the storage device 7006, the high-speed interface 7008, the high-speed expansion ports 7010, and the low-speed interface 7012, are interconnected using various busses, and may be mounted on a common motherboard or in other manners as appropriate. The processor 7002 can process instructions for execution within the computing device 7000, including instructions stored in the memory 7004 or on the storage device 7006 to display graphical information for a GUI on an external input/output device, such as a display 7016 coupled to the high-speed interface 7008. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 7004 stores information within the computing device 7000. In some implementations, the memory 7004 is a volatile memory unit or units. In some implementations, the memory 7004 is a non-volatile memory unit or units. The memory 7004 may also be another form of computer-readable medium, such as a magnetic or optical disk.

The storage device 7006 is capable of providing mass storage for the computing device 7000. In some implementations, the storage device 7006 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 7002), perform one or more methods, such as those described above. The instructions can also be stored by one or more storage devices such as computer- or machine-readable mediums (for example, the memory 7004, the storage device 7006, or memory on the processor 7002).

The high-speed interface 7008 manages bandwidth-intensive operations for the computing device 7000, while the low-speed interface 7012 manages lower bandwidth-intensive operations. Such allocation of functions is an example only. In some implementations, the high-speed interface 7008 is coupled to the memory 7004, the display 7016 (e.g., through a graphics processor or accelerator), and to the high-speed expansion ports 7010, which may accept various expansion cards (not shown). In the implementation, the low-speed interface 7012 is coupled to the storage device 7006 and the low-speed expansion port 7014. The low-speed expansion port 7014, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 7000 may be implemented in a number of different forms, as shown in the figure. For example, it may be implemented as a standard server 7020, or multiple times in a group of such servers. In addition, it may be implemented in a personal computer such as a laptop computer 7022. It may also be implemented as part of a rack server system 7024. Alternatively, components from the computing device 7000 may be combined with other components in a mobile device (not shown), such as a mobile computing device 7050. Each of such devices may contain one or more of the computing device 7000 and the mobile computing device 7050, and an entire system may be made up of multiple computing devices communicating with each other.

The mobile computing device 7050 includes a processor 7052, a memory 7064, an input/output device such as a display 7054, a communication interface 7066, and a transceiver 7068, among other components. The mobile computing device 7050 may also be provided with a storage device, such as a micro-drive or other device, to provide additional storage. Each of the processor 7052, the memory 7064, the display 7054, the communication interface 7066, and the transceiver 7068, are interconnected using various buses, and several of the components may be mounted on a common motherboard or in other manners as appropriate.

The processor 7052 can execute instructions within the mobile computing device 7050, including instructions stored in the memory 7064. The processor 7052 may be implemented as a chipset of chips that include separate and multiple analog and digital processors. The processor 7052 may provide, for example, for coordination of the other components of the mobile computing device 7050, such as control of user interfaces, applications run by the mobile computing device 7050, and wireless communication by the mobile computing device 7050.

The processor 7052 may communicate with a user through a control interface 7058 and a display interface 7056 coupled to the display 7054. The display 7054 may be, for example, a TFT (Thin-Film-Transistor Liquid Crystal Display) display or an OLED (Organic Light Emitting Diode) display, or other appropriate display technology. The display interface 7056 may comprise appropriate circuitry for driving the display 7054 to present graphical and other information to a user. The control interface 7058 may receive commands from a user and convert them for submission to the processor 7052. In addition, an external interface 7062 may provide communication with the processor 7052, so as to enable near area communication of the mobile computing device 7050 with other devices. The external interface 7062 may provide, for example, for wired communication in some implementations, or for wireless communication in other implementations, and multiple interfaces may also be used.

The memory 7064 stores information within the mobile computing device 7050. The memory 7064 can be implemented as one or more of a computer-readable medium or media, a volatile memory unit or units, or a non-volatile memory unit or units. An expansion memory 7074 may also be provided and connected to the mobile computing device 7050 through an expansion interface 7072, which may include, for example, a SIMM (Single In Line Memory Module) card interface. The expansion memory 7074 may provide extra storage space for the mobile computing device 7050, or may also store applications or other information for the mobile computing device 7050. Specifically, the expansion memory 7074 may include instructions to carry out or supplement the processes described above, and may include secure information also. Thus, for example, the expansion memory 7074 may be provided as a security module for the mobile computing device 7050, and may be programmed with instructions that permit secure use of the mobile computing device 7050. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 7052), perform one or more methods, such as those described above. The instructions can also be stored by one or more storage devices, such as one or more computer- or machine-readable mediums (for example, the memory 7064, the expansion memory 7074, or memory on the processor 7052). In some implementations, the instructions can be received in a propagated signal, for example, over the transceiver 7068 or the external interface 7062.

The mobile computing device 7050 may communicate wirelessly through the communication interface 7066, which may include digital signal processing circuitry where necessary. The communication interface 7066 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 7068 using a radio-frequency. In addition, short-range communication may occur, such as using a Bluetooth®, Wi-Fi™, or other such transceiver (not shown). In addition, a GPS (Global Positioning System) receiver module 7070 may provide additional navigation- and location-related wireless data to the mobile computing device 7050, which may be used as appropriate by applications running on the mobile computing device 7050.

The mobile computing device 7050 may also communicate audibly using an audio codec 7060, which may receive spoken information from a user and convert it to usable digital information. The audio codec 7060 may likewise generate audible sound for a user, such as through a speaker, e.g., in a handset of the mobile computing device 7050. Such sound may include sound from voice telephone calls, may include recorded sound (e.g., voice messages, music files, etc.) and may also include sound generated by applications operating on the mobile computing device 7050.

The mobile computing device 7050 may be implemented in a number of different forms, as shown in the figure. For example, it may be implemented as a cellular telephone 7080. It may also be implemented as part of a smart-phone 7082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method for managing service level agreements associated with one or more vendors and/or products, the method comprising the steps of:
causing to display, by a processor of an enterprise system, one or more graphical user interfaces (GUIs) associated with one or more service level agreement modules, the service level agreement modules comprising one or more members selected from the group consisting of:
(i) a set up module to set up and/or establish a new service level agreement (e.g., a service level agreement entry in a database of the enterprise system);
(ii) a record module to record (e.g., in a database of the enterprise system) performance of one or more service level agreements;
(iii) a remediate module to manage remediation of one or more service level agreements; and
(iv) a manage module to display information (e.g., statistical information) relating to one or more service level agreements;
receiving, by a processor of an enterprise system, a first input from a first client user (e.g., said first client user having been authorized to access the enterprise system, e.g., said first client user being one member of a network of subscribed clients), the first input comprising instructions to access a selected module of the one or more service level agreement modules;
receiving, by the processor of the enterprise system, subsequent input from the first client user specific to the selected service level agreement module; and
updating, in a memory of the enterprise system, service level agreement information stored in association with the first client, based on the subsequent input;
wherein the service level agreement module is configured to define and track performance metrics associated with one or more service level agreements.

2. The method of claim 1, where the one or more graphical user interfaces (GUIs) associated with one or more service level agreement modules comprises a service level agreement home GUI, the service level agreement home GUI comprising:
(i) a selectable (e.g., clickable) set up tile associated with the set up module;
(ii) a selectable (e.g., clickable) record tile associated with the record module;
(iii) a selectable (e.g., clickable) remediate tile associated with the a remediate module; and
(iv) a selectable (e.g., clickable) manage tile associated with a manage module.

3. The method of claim 2, wherein the first input comprises instructions to access the set up module (e.g., by clicking the set up tile on the a service level agreement home GUI), and wherein a subsequent input comprises custom data field information relating to a service level agreement (e.g., received via a graphical user interface widget), the custom data field information including one or more identifiers and/or one or more monitoring parameters associated with the service level agreement.

4. The method of claim 2, comprising:
interrogating, by the processor, a database of the enterprise system to determine whether at least one service level agreement entry have been set up in the database of the enterprise system; and
if no service level agreement entry is found, blocking (e.g., rendering non-clickable) one or more of the record tile, the remediate tile, and/or the manage tile, and
if at least one service level agreement entry is found, activating (e.g., rendering clickable) one or more of the record tile, the remediate tile, and/or the manage tile.

5. The method of claim 1, wherein a first input comprises instructions to access the record module, and wherein a subsequent input comprises custom data field information including one or more filter parameters.

6. The method of claim 5, comprising:
interrogating, by the processor, an electronic calendar to determine a current date;
interrogating, by the processor, a database of the enterprise system, to retrieve, for one or more service level agreement entries, one or more review windows comprising a start date and an end date, and one or more as-of dates associated with one or more reviews; and
if, for a first service level agreement, the current date is one day greater than the start date of a first review windows and if none of the one or more as-of dates that falls within the first review window, assigning to the first service level agreement a past due value; and
displaying, on a monitoring GUI, a past due reminder date (e.g., in a font color different from a default font color for display of reminder dates that are not past due).
